(19) United States
(12) Patent Application Publication
(10) Pub. No.: US 2016/0268866 A1
(43) Pub. Date: Sep. 15, 2016

(54) AXIAL GAP TYPE ROTATING ELECTRICAL MACHINE

(71) Applicant: HITACHI, LTD., Tokyo (JP)

(72) Inventor: Hironori MATSUMOTO, Tokyo (JP)

(73) Assignee: HITACHI, LTD., Tokyo (JP)

(21) Appl. No.: 15/030,677

(22) PCT Filed: Nov. 22, 2013
(86) PCT No.: PCT/JP2013/081503

§ 371 Date: Apr. 20, 2016

(51) Int. Cl. H02K 5/22; H02K 15/03; H02K 5/02; H02K 1/18; H02K 1/27

(52) U.S. Cl. CPC H02K 5/225; H02K 1/182; H02K 1/2793; H02K 5/02; H02K 15/03

(57) ABSTRACT

An axial gap type rotating electrical machine includes: a rotor that is fixed to a rotation shaft; a stator that is arranged to face the rotor along an axial direction of the rotation shaft; a housing that contains the rotor and the stator; and a resin member for holding the stator to an inner wall of the housing; wherein: the stator comprises a plurality of cores that are arranged in a circumferential direction around the rotation shaft, an insulating bobbin that holds each of the cores, a coil that is wound upon the bobbin, and a first conductive member for shielding electrostatic coupling between the coil and the rotor; the bobbin is formed with an opening portion for housing the core and a flange portion that surrounds the opening portion; and the flange portion is formed with a groove portion in which the first conductive member is housed.

### TECHNICAL FIELD

The present invention relates to an axial gap type rotating electrical machine.

### BACKGROUND ART

A rotating electrical machine (i.e., a molded motor) in which a stator core is integrally molded from molding resin is per se known (refer to PTL 1). A rotating electrical machine is described in PTL 1 in which a conductive member that electrically connects together a first bracket and a second bracket is buried in a molded body (a molded resin portion).

### CITATION LIST

### Patent Literature

PTL 1: Japanese Laid-Open Patent Publication No. 2011-67069

### SUMMARY OF INVENTION

### Technical Problem

With a rotating electrical machine (i.e., a molded motor) in which the stator is covered with an insulating resin such as the rotating electrical machine described in PTL 1, the stator is in an electrically floating state. Due to this, an axial voltage is set up due to the potential difference between the stator and the rotation shaft of the rotor, and, due to the axial current that is thereby created, stray current corrosion may occur in the interior of the bearings.

### Solution to Technical Problem

An axial gap type rotating electrical machine according to a first aspect of the present invention comprises: a rotor that is fixed to a rotation shaft; a stator that is arranged to face the rotor along an axial direction of the rotation shaft; a housing that contains the rotor and the stator; and a resin member for holding the stator to an inner wall of the housing; wherein: the stator comprises a plurality of cores that are arranged in a circumferential direction around the rotation shaft, an insulating bobbin that holds each of the cores, a coil that is wound upon the bobbin, and a first conductive member for shielding electrostatic coupling between the coil and the rotor; the bobbin is formed with an opening portion for housing the core and a flange portion that surrounds the opening portion; and the flange portion is formed with a groove portion in which the first conductive member is housed.

### Advantageous Effects of Invention

According to the present invention, it is possible to prevent the occurrence of stray current corrosion at the bearings.

### BRIEF DESCRIPTION OF DRAWINGS

FIG. 1 is a cutaway perspective view showing the structure of an axial gap type rotating electrical machine according to a first embodiment of the present invention;

FIG. 2 is another cutaway perspective view showing the structure of the axial gap type rotating electrical machine according to the first embodiment of the present invention (a molded body and two rotors are not shown in this figure);

FIG. 3 is an enlarged partial perspective view showing a stator core, a conductive ring, and conductive bars;

FIG. 4 is a perspective view showing the structure of the stator core;

FIG. 5 is a perspective view showing the structure of a bobbin;

FIG. 6 is a perspective view showing the structure of the conductive ring;

FIG. 7 is a perspective view showing an electrical connection portion between the conductive ring and the stator core;

FIG. 8 is a flow chart for explanation of a process for manufacturing the rotating electrical machine;

FIG. 9 is a flow chart for explanation of a positioning process;

FIG. 10 is a schematic cross sectional figure for explanation of a process of arranging a lower conductive ring and the stator cores;

FIG. 11 is a schematic cross sectional figure for explanation of a process of arranging a center bracket and an upper conductive ring;

FIG. 12 is a figure showing a state before a projecting portion of a conductive ring is bent;

FIG. 13 shows figures for explanation of a process of inserting a bending tool into a slot of the projecting portion of the conductive ring;

FIG. 14 shows figures for explanation of a process of bending a bent prong by rotating the bending tool that has been inserted into the slot;

FIG. 15 is a figure for explanation of a state in which the bent prong has been pressed against a side surface of a stator core in the circumferential direction;

FIG. 16(a) is an enlarged view of a portion of FIG. 15, and FIG. 16(b) is a figure for explanation of a portion of the side surface in the circumferential direction of the stator core that has been deformed;

FIG. 17 is a schematic cross sectional figure showing how a resin charging space is defined by a lower mold and a upper mold;

FIG. 18 is a schematic cross sectional figure showing a state in which a plurality of the cores have been integrally molded together;

FIG. 19 shows schematic cross sectional figures showing the relationship between one of the cores and a molded body;

FIG. 20 is a cutaway perspective view showing the structure of an axial gap type rotating electrical machine according to a second embodiment of the present invention;

FIG. 21 is a figure showing one core and one conductive member of FIG. 20 as seen along the axial direction;

FIG. 22 is a cutaway perspective view showing the structure of an axial gap type rotating electrical machine according to a third embodiment of the present invention;

FIG. 23 is a schematic cross sectional figure taken in a plane parallel to the axial direction and including a center line m that divides into halves the width in the circumferential direction of a core shown in FIG. 22;

FIG. 24 is a partly cut away perspective view showing a holding member holding a core during the molding process;

FIG. 25 is a schematic cross sectional figure showing how a resin charging space is defined by a lower mold and an upper mold;

FIG. 26(a) is a cutaway perspective view showing the structure of an axial gap type rotating electrical machine according to a variant of the third embodiment of the present invention, and FIG. 26(b) is a figure showing a die contacting region provided upon the end surface of one of the stator cores; and

FIG. 27 is a schematic cross sectional view showing how a resin charging space is defined by a lower mold and an upper mold.

### DESCRIPTION OF EMBODIMENTS

In the following, embodiments of axial gap type rotating electrical machines according to the present invention (which are axial gap type motors) will be explained with reference to the drawings.

### First Embodiment

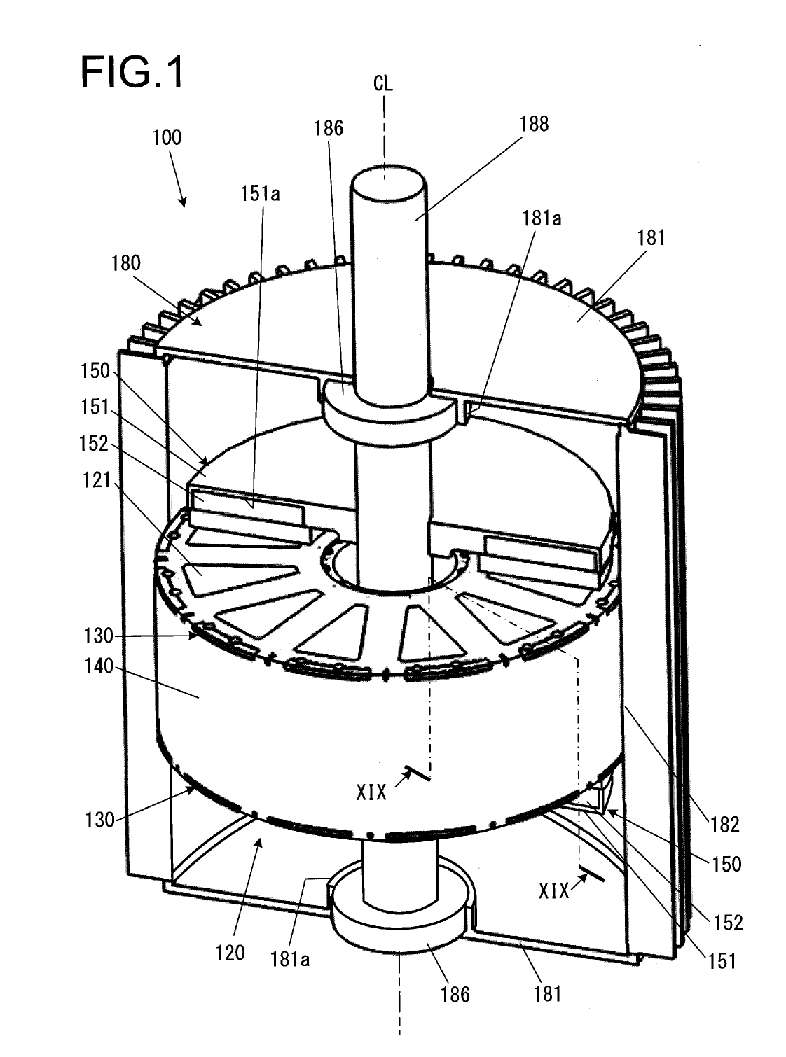

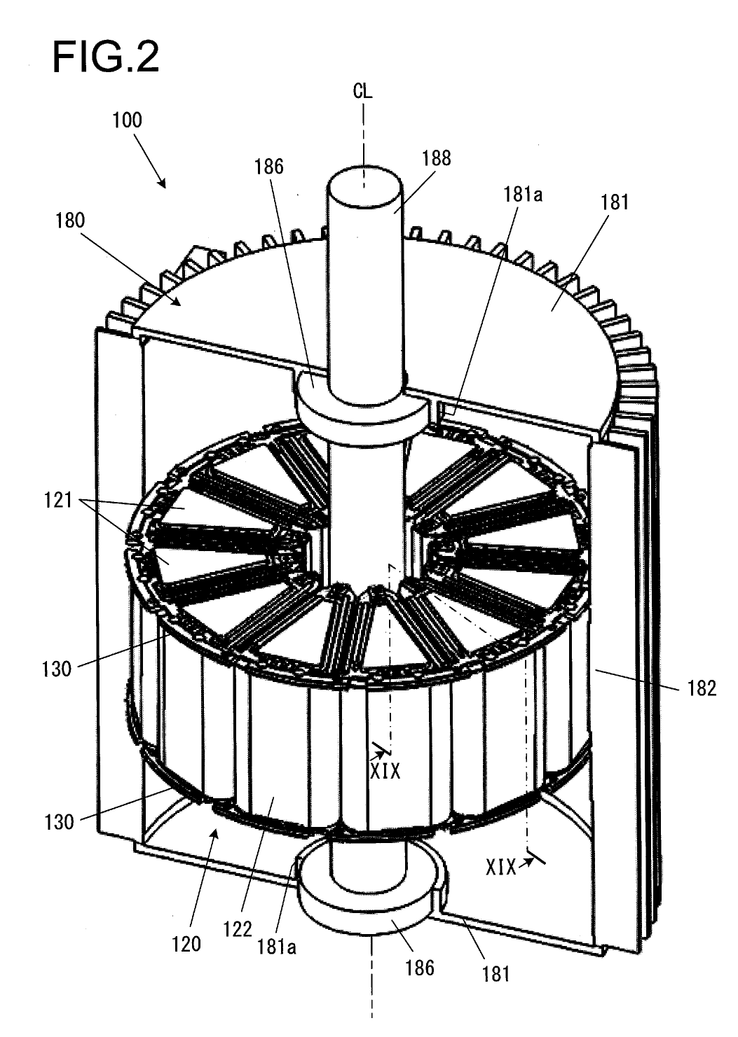

FIGS. 1 and 2 are cutaway perspective views showing the structure of an axial gap type rotating electrical machine according to a first embodiment of the present invention, with a molded body 140 and rotors 150 being omitted from FIG. 2. In FIGS. 1 and 2, a housing 180 and the rotors 150 are shown as being sectioned by a plane that includes the central axis CL of a rotation shaft 188, and that moreover is parallel to the axial direction of the rotation shaft 188 (hereinafter this is also sometimes simply termed the “axial direction”). It should be understood that coils 122 are only shown schematically in the figures, each of these coils 122 consisting of a plurality of winding turns of a conductor having an insulation coating, wound upon a stator core 121.

This axial gap type rotating electrical machine (hereinafter simply termed the “rotating electrical machine 100”) comprises the rotation shaft 188, a pair of rotors 150 that are fixed to the rotation shaft 188, a stator 120 that is disposed between the pair of rotors 150, and the housing 180 that houses the pair of rotors 150 and the stator 120. The rotating electrical machine 100 of this embodiment is an axial gap type rotating electrical machine of the two rotor one stator type, having a construction in which the stator 120 is sandwiched between the pair of rotors 150 with predetermined gaps being left therebetween, and, because it can obtain higher magnetic flux, is superior as compared with a one rotor one stator axial gap type rotating electrical machine from the standpoints that the efficiency and the specific power can be increased.

The pair of rotors 150 are arranged to face one another along the axial direction with a predetermined gap being left between them. Since both the pair of rotors 150 are formed to have similar shapes, only one of these rotors 150 will be explained as a representative. The rotor 150 is provided with an axial hole through which the rotation shaft 188 passes. Due to the rotation shaft 188 being inserted into this axial hole and being fixed therein, the rotor 150 and the rotation shaft 188 are formed into an integrated body.

The rotor 150 comprises a casing member 151 that is approximately formed as a circular plate and a plurality of magnets 152. Concave portions 151a into which the magnets 152 are fitted are provided to the casing member 151, arranged along the circumferential direction of the rotation shaft 188 (hereinafter this will simply be termed the “circumferential direction”). The magnets 152 are disposed in the concave portions 151a at regular intervals along the circumferential direction. Each of the magnets 152 is magnetized along the axial direction, so that one side thereof becomes an S pole while the other side thereof becomes an N pole. And the magnets 152 are arranged along the circumferential direction so that their neighboring magnetic poles have opposite polarities, in other words so that their polarities are N, S, N, S, . . . .

As seen along the axial direction, each one of the magnets 152 in one of the pair of rotors 150 and a corresponding magnet 152 in the other rotor 150 are positioned at the same position in the circumferential direction, and moreover have the same shape. Neodymium-based or samarium-based sintered magnets, ferrite magnets, or neodymium-based bonded magnets may be employed for the magnets 152.

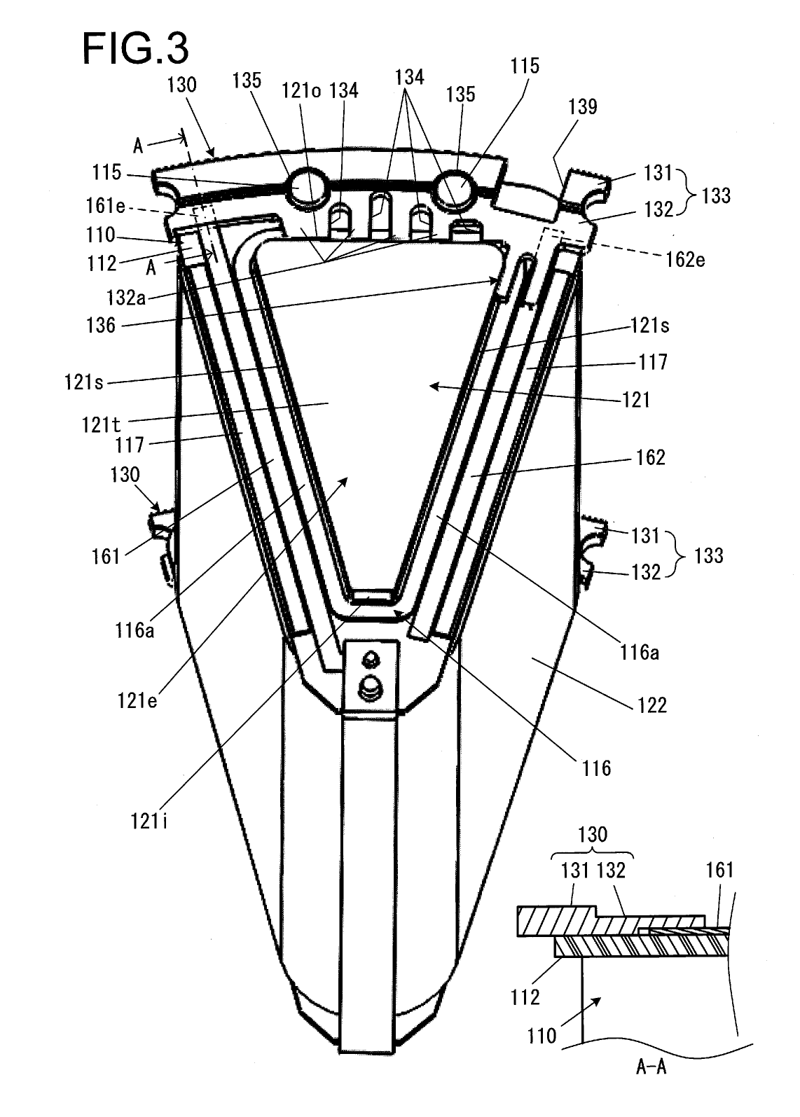

The stator 120 is arranged to face the rotors 150 along the axial direction. As shown in FIGS. 2 and 3, the stator 120 comprises a plurality of stator cores 121 (hereinafter these are sometimes simply termed “cores”) that are arranged at regular intervals along the circumferential direction, stator coils 122 (hereinafter these are sometimes simply termed is “coils”) that are installed upon these cores 121 via bobbins 110, conductive bars 161, 162 (refer to FIG. 3) that are installed upon the bobbins 110 of the cores 121, and a pair of conductive rings 130 that are disposed at the two ends of the stator 120 in the axial direction; and, as shown in FIG. 1, all these members are integrally molded together within the housing 180 by the use of an insulating resin. Slots in the stator 120 are open slots.

As shown in FIG. 1, the cores 121 comprised in the stator 120 are held by a mold formed mass 140 of insulating resin (hereinafter termed the “molded body 140”), and this molded body 140 is adhered to an inner wall of a center housing 182 of the housing 180.

The housing 180 is made from an electrically conductive metallic material. This housing 180 comprises the cylindrical center housing 182, which is provided with heat dissipation fins, and a pair of housing end members 181 that close apertures at both ends of the center housing 182. The space surrounded by the center housing 182 and the pair of housing end members 181 constitutes a housing space that houses the pair of rotors 150 and the stator 120. The housing end members 181 are provided with through holes through which the rotation shaft 188 passes and with bearing support portions 181a that support bearings 186. The rotation shaft 188 is supported by the bearings 186 so as to be rotatable.

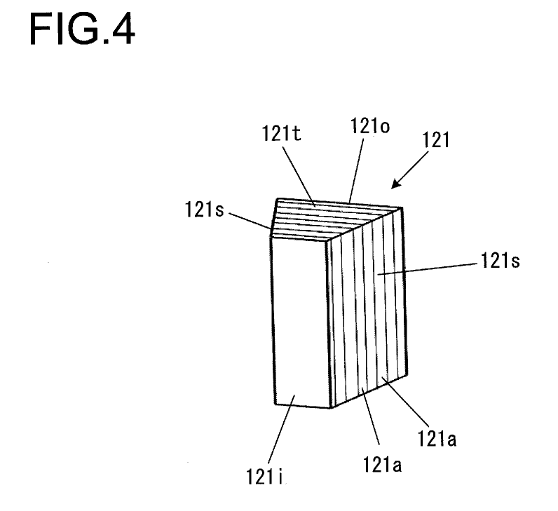

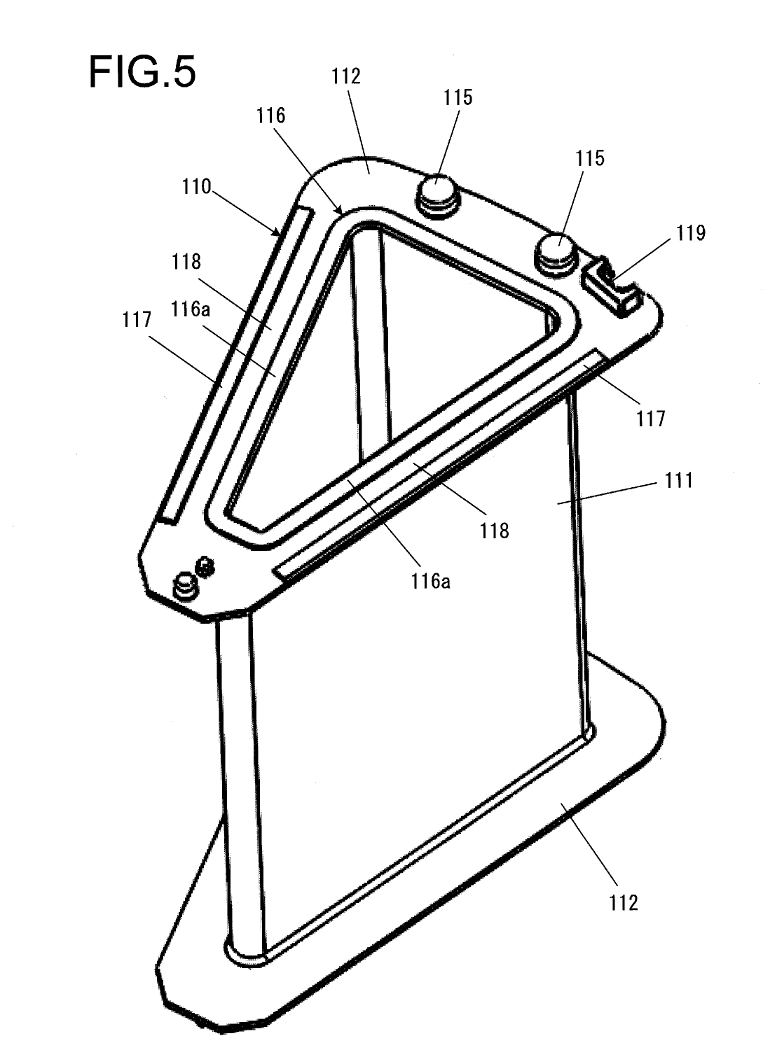

FIG. 3 is an enlarged partial perspective view showing one of the cores 121 and an associated conductive ring 130 and the conductive bars 161, 162. Moreover, a schematic cross sectional view thereof taken along a line A-A is also shown in FIG. 3. And FIG. 4 is a perspective view showing the structure of the core 121, while FIG. 5 is a perspective view showing the structure of the bobbin 110. As shown in FIG. 4, the core 121 is made by laminating together a plurality of thin magnetic plates 121a that are made from an amorphous metal based upon iron, and is approximately formed as a trapezoidal prism. It should be understood that it would also be acceptable to provide layers of insulation between the thin magnetic plates 121a. The thickness of the thin magnetic plates 121a is exaggerated in FIG. 4. The actual thickness of the thin magnetic plates 121a may, for example, be around 0.2 to 0.3 mm, and around 300 to 500 of the thin magnetic plates 121a may be laminated together to constitute the core 121.

In the following explanation, for convenience, as shown in FIG. 4, the outer surfaces of the core 121 will be defined and explained as follows. Among the outer surfaces of the core 121, its surface that is closest to the rotation shaft 188 and that is parallel thereto, in other words its surface that faces the rotation shaft 188, will be termed its inner surface 121i. And its surface that is closest to the center housing 182 of the housing 180 and that is parallel thereto, in other words its surface that faces the center housing 182, will be termed its outer surface 121o. Moreover, among the side surfaces of the core 121, the two surfaces parallel to its axial direction that join between its inner surface 121i and its outer surface 121o, in other words its two end surfaces in the circumferential direction that confront neighboring cores 121, will be termed its side surfaces 121s. And both the end surfaces of the core 121 in both axial directions, which face the respective rotors 150, will be termed its end surfaces 121t.

In each one of the plurality of cores 121 that are arranged in the circumferential direction as shown in FIGS. 1 and 2, the direction of lamination of the plurality of thin magnetic plates 121a that make up that core 121 and the radial direction of the rotation shaft 188 (hereinafter also simply termed the “radial direction”) are the same. Or, to put it in another manner, the planes of the thin magnetic plates 121a are orthogonal to directions radial to the rotation shaft 188. Due to this, it is possible to suppress generation of eddy currents due to the magnetic flux generated during the operation of the rotating electrical machine 100.

As shown in FIG. 3, the core 121 is held by the bobbin 110. The bobbin 110 is made from an insulating resin material. As shown in FIG. 5, the bobbin 110 comprises a barrel portion 111 that is shaped approximately as a trapezoidal tube, and a pair of flange portions 112 that project outward from the barrel portion 111 at both its ends in the axial direction. As described hereinafter, the coil 122 is formed by winding a conducting wire that is covered with an insulating surface coating a predetermined number of times upon the outer circumferential surface of the barrel portion 111 (refer to FIG. 3).

As shown in FIG. 5, an opening portion for receiving the core 121 is provided in the barrel portion 111, and the flange portions 112 are provided so as to surround this opening portion. Inner edge portions 116 are provided upon the flange portions 112 along the edges of their opening portions. As seen along the axial direction, these inner edge portions 116 are approximately shaped as equilateral trapezoids, and outer edge portions 117 are provided along the outer edges of the flange portions 112 so as to oppose long side portions 116a that correspond to the sides of the trapezoids. The long side portions 116a of the inner edge portion 116 and the outer edge portions 117 that oppose these long side portions 116a are arranged so as to be mutually parallel and a predetermined distance apart. The inner edge portions 116 and the outer edge portions 117 are provided so as to project in the axial direction from the plane portions of the flange portions 112, so that groove portions 118 of a predetermined width are defined by the plane portions of the flange portion 112 and by the inner edge portions 116 and the outer edge portions 117. A pair of these groove portions 118 are defined on each of the flange portions 112.

As shown in FIG. 3, the conductive bar 161 is received in one of the pair of groove portions 118, while the conductive bar 162 is received in the other. Each of these conductive bars 161, 162 has a rectangular cross sectional shape. And each of the conductive bars 161, 162 is formed to have a width that is the same as, or slightly greater than, the width of the groove portion 118 in which it is received, so that the conductive bars 161, 162 are fixed by being fitted into the groove portions 118. Each of the conductive bars 161, 162 is formed to be longer than its long side portion 116a of the inner edge portion 116, and, for each of the conductive bars 161, 162, its one end is positioned to be more radially inward than the one end of its long side portion 116a, while its other end is positioned to be more radially outward than the other end of its long side portion 116a. Since the conductive bars 161, 162 are disposed between the coils 122 and the rotor 150, accordingly electrostatic coupling between the coils 122 and the rotor 150 is shielded.

Radially outward end portions 161e, 162e of the conductive bars 161, 162 are sandwiched between an inner circumferential portion 132 of the conductive ring 130 that will be described hereinafter and a flange portion 112 of the bobbin 110, and thereby the conductive bars 161, 162 and the conductive ring 130 are electrically and mechanically connected together. It should be understood that, as shown by the schematic cross sectional figure in FIG. 3 that is taken in a plane shown by the line A-A, a step (i.e. a difference in level) is formed on the flange portion 112 side of the inner circumferential portion 132 of the conductive ring 130, so that the radially inward portion of the inner circumferential portion 132 becomes a thinner portion that is formed to be thinner than the thickness of the radially outward portion of the inner circumferential portion 132. The end portions 161e, 162e of the conductive bars 161, 162 are contacted against and held by this thinner portion on the radially inward side of the inner circumferential portion 132.

The length of the core 121 in the axial direction is longer than the length of the bobbin 110 in the axial direction, and thus the two end portions of the core 121 in the axial direction project by predetermined distances from the openings at both ends of the barrel portion 111. In the following, the two end portions of the core 121 that project from the bobbin 110 will both be termed “projecting end portions 121e”. Due to this, with the exception of the projecting end portions 121e, the inner surface 121i of the core 121, its outer surface 121o, and its pair of side surfaces 121s are covered by the barrel portion 111, while the inner surfaces 121i of the projecting end portions 121e, their outer surfaces 121o, their pairs of side surfaces 121s, and also their end surfaces 121t are exposed.

As shown in FIG. 5, two pins 115 and a takeout portion 119 are provided to the flange portion 112 of the bobbin 110, on its side towards the center housing 182. On each of the pair of flange portions 112, the two pins 115 are provided as standing up on that flange portion 112, so that they extend parallel to the axial direction. And the takeout portion 119 is a portion through which lead wires of the coil 122 are passed, and this is formed upon only one of the pair of flange portions 119.

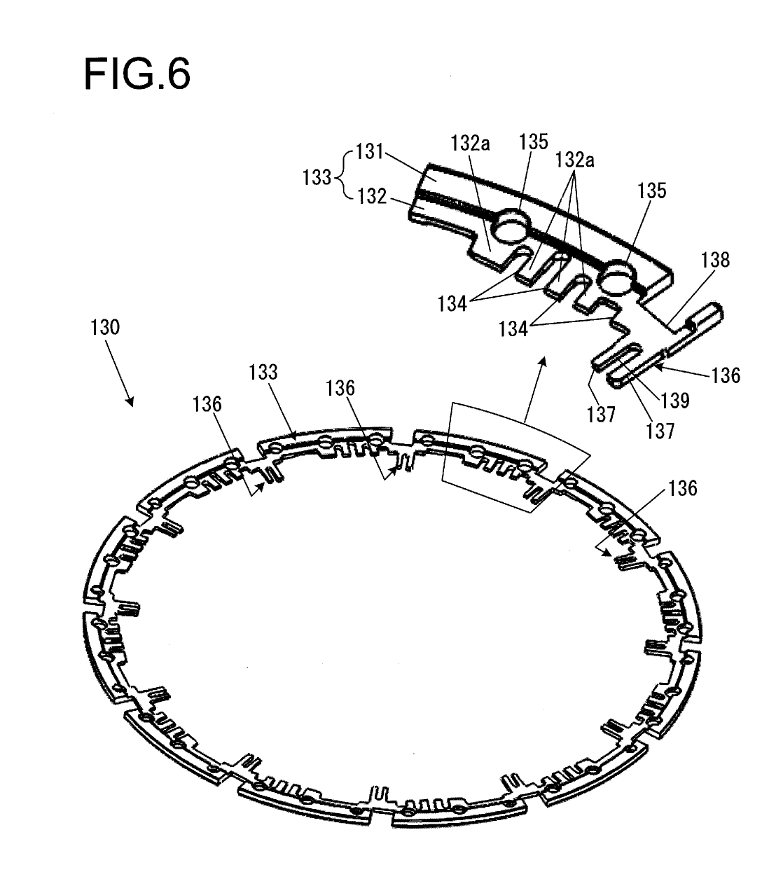

As shown in FIGS. 1 and 2, each of the pair of conductive rings 130 that are disposed at both end portions of the stator 120 in the axial direction has the same shape. Due to this, only one of these conductive rings 130 will be explained, while explanation of the other conductive ring 130 will be omitted. FIG. 6 is a perspective view showing the structure of this conductive ring 130. The conductive ring 130 is an electrically conductive member that electrically connects together the core 121 and the center housing 182. And, as shown in FIG. 6, the conductive ring 130 comprises a circular base portion 133 that is contacted against the inner surface of the center housing 182 and a plurality of projecting portions 136 that project from this circular base portion 133 toward the center of the rotation shaft 188.

As shown in FIG. 3, each of the plurality of projecting portions 136 is contacted against the side surface 121s of a corresponding one of the plurality of the cores 121. It should be understood that although, in this embodiment, the projecting portion 136 is contacted against only one of the pair of side surfaces 121s of the core 121, alternatively, it would also be acceptable to make projecting portions 136 to contact against both of the pair of side surfaces 121s.

As shown in FIG. 6, the thickness of the base portion 133 of the conductive ring 130 is different between an annular portion 131 on its external circumferential side (hereinafter termed its “outer circumferential portion 131”) and an annular portion 132 on its internal circumferential side (hereinafter termed its “inner circumferential portion 132”), so that a difference in level (i.e. a step) is formed on its side that is opposite to the flange portion 112 side. The thickness of this outer circumferential portion 131 is around 3 mm, while the thickness of the inner circumferential portion 132 is around 1 mm. Furthermore, as described above, a step is also formed at the surface of the inner circumferential portion 132 on the flange portion 112 side, so that the radially inward portion of the inner circumferential portion 132 is made as a thin portion against which the respective end portions 161e, 162e of the conductive bars 161, 162 are contacted.

Fitting holes 135 are provided in the base portion 133, with the pins 115 described above that are provided in the bobbin 110 being fitted thereinto. And a cutaway portion 138 is provided in the base portion 133, with the takeout portion 119 described above that is provided upon the bobbin 110 being disposed therein.

A plurality of slits 134 are provided in the inner circumferential portion 132 of the base portion 133, extending radially outward from its internal circumferential edge surface and spaced in sequence in its circumferential direction. To put this in another manner, a plurality of prongs 132a are provided as extending from the outer circumferential portion 131 in the radially inward direction and spaced along the circumferential direction. The shapes of the plurality of slits 134 are set by taking into account the positional relationship with the fitting holes 135, so that the fitting holes 135 and the slits 134 do not interfere with one another.

The projecting portions 136 are provided to project radially inwards, so that they extend from the base portion 133 along the radially inward direction. And slots 139 are provided in the projecting portions 136, extending in the radially outward direction from the ends of the projecting portions 136. To put this in another way, each projecting portion 136 is divided into two projecting prongs 137 by the slot 139, and is thus formed in bifurcated shapes.

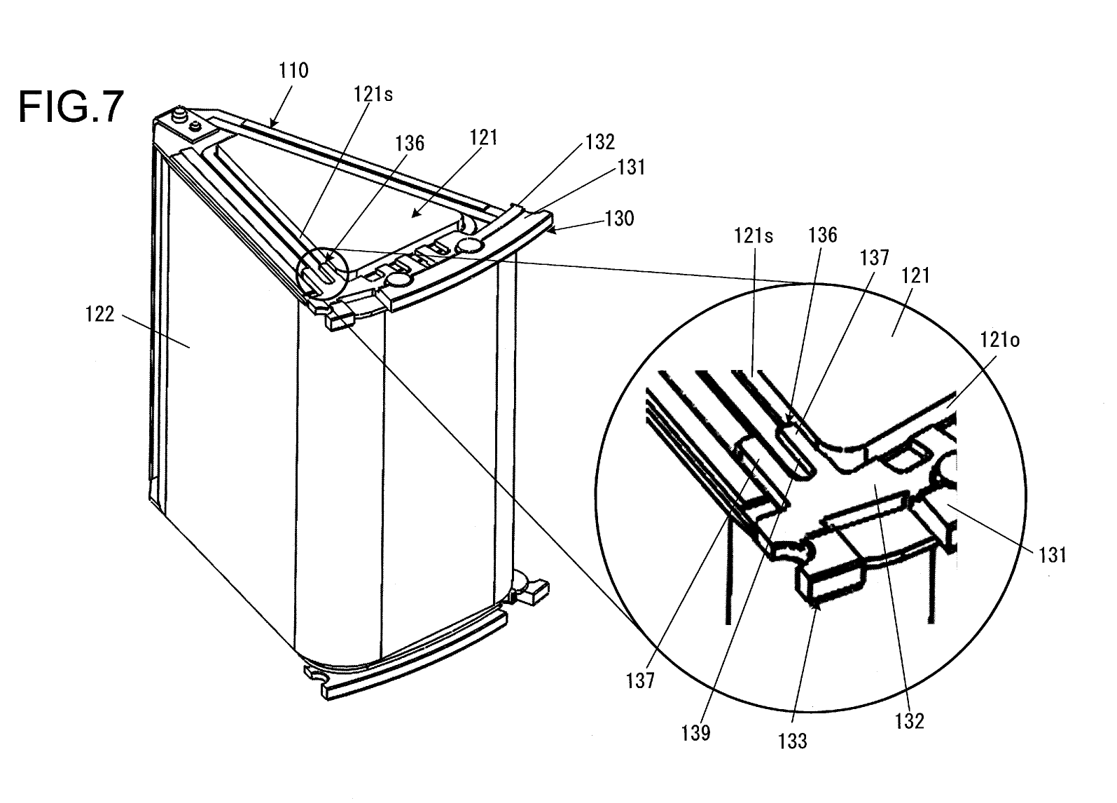

FIG. 7 is a perspective view showing the structure of the electrical connection portion between the conductive ring 130 and the stator core 121. As shown in FIG. 7, among the pair of projecting prongs 137, the one of the projecting prongs 137 that is closer to the core 121 is contacted against the side surface 121s of the core 121.

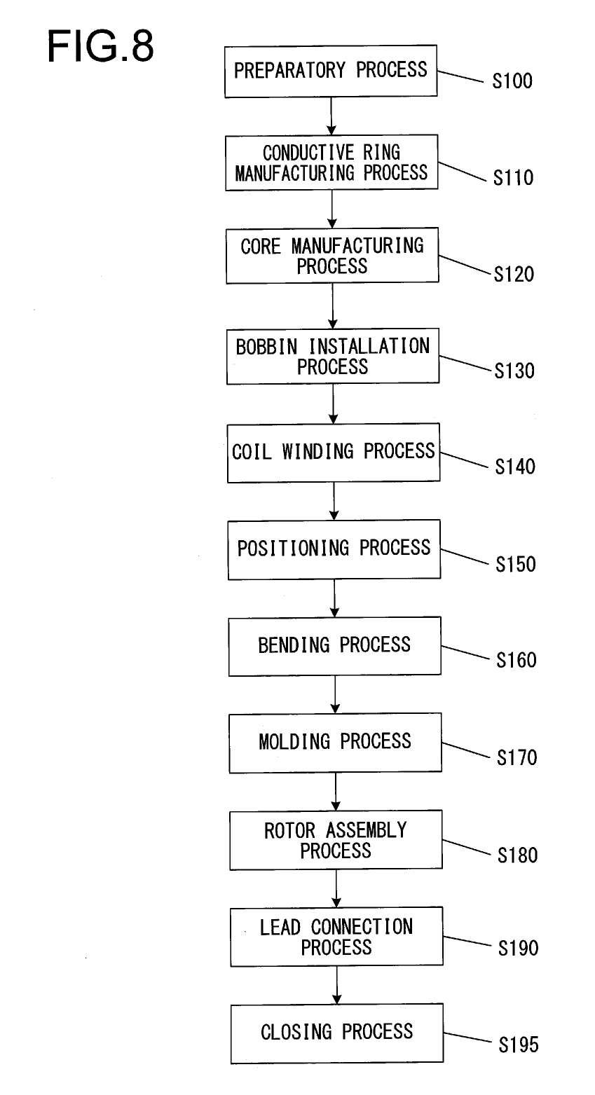

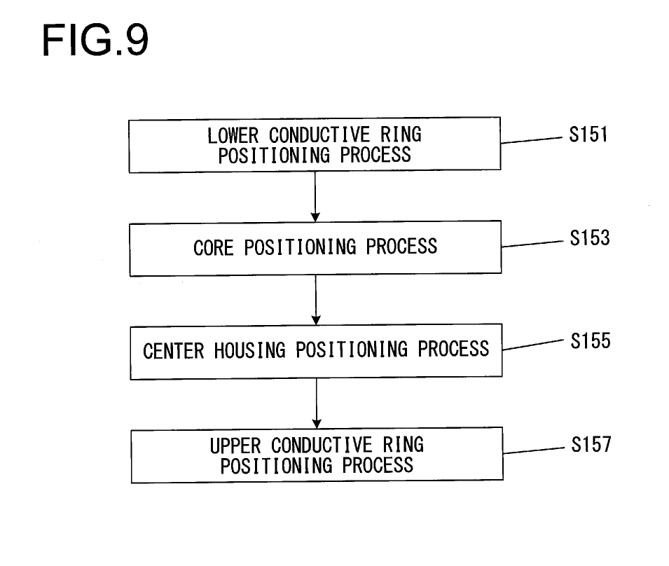

A method for manufacturing this rotating electrical machine 100 will now be explained. FIG. 8 is a flow chart for explanation of the process for manufacturing this rotating electrical machine 100, and FIG. 9 is a flow chart for explanation of a positioning process. As shown in FIG. 8, this method for manufacturing the rotating electrical machine 100 includes a preparatory process S100, a conductive ring manufacturing process S110, a core manufacturing process S120, a bobbin installation process S130, a coil winding process S140, a positioning process S150, a bending process S160, a molding process S170, a rotor assembly process S180, a lead connection process S190, and a closing process S195.

### —the Preparatory Process—

In the preparatory process S100, the various components that make up the rotating electrical machine 100 are prepared: for example, the center housing 182, the housing end members 181, the thin magnetic plates 121a that make up the core 121, the rotors 150, and so on are prepared. And the rotation shaft 188 is installed into one of the pair of rotors 150.

### —the Conductive Ring Manufacturing Process—

In the process S110 for manufacturing the conductive rings, the conductive rings 130 are formed by performing pressing processing upon a plate shaped member that is made from an electrically conductive metallic material.

### —The Core Manufacturing Process—

In the core manufacturing process S120, each of the cores 121 is manufactured by stacking together a predetermined number of elongated rectangular plates of amorphous foil strip that are made from an iron-based amorphous metal, then are pressed from both sides in the direction in which they are stacked, and then are subjected to cutting processing so as to be formed, approximately, into a trapezoidal prism.

### —the Bobbin Installation Process—

In the bobbin installation process S130, the cores 121 that have been made in the core manufacturing process S120 are press-fitted into the opening portions of the barrel portions 111 of the bobbins 110. Both end portions of each of the cores 121 are projected from the two ends of the barrel portion of the corresponding bobbin 110. The end surfaces 121t that constitute the two end surfaces of the core 121 are set to positions at a predetermined distance from the flange portions of the bobbin 110. And the conductive bars 161, 162 are fitted into the groove portions 118 of the flange portions 112.

### —the Coil Winding Process—

In the coil winding process S140, each of the coils 122 is formed by winding a predetermined number of turns of conductive wire having an insulation coating upon the barrel portion 111 of the corresponding bobbin 110. In other words, the coil 122 is installed upon the core 121 via the bobbin 110. And the lead wire of the coil 122 is disposed in the opening of the takeout portion 119 that is provided in the flange portion 112 of the bobbin 110.

### —the Positioning Process—

In the positioning process S150, the cores 121, the two conductive rings 130, and the center housing 182 are arranged in their predetermined positions. As shown in FIG. 9, this positioning process S150 includes a process S151 of positioning the lower conductive ring 130, a process S153 of positioning the cores 121, a process S155 of positioning the center housing 182, and a process S157 of positioning the upper conductive ring 130.

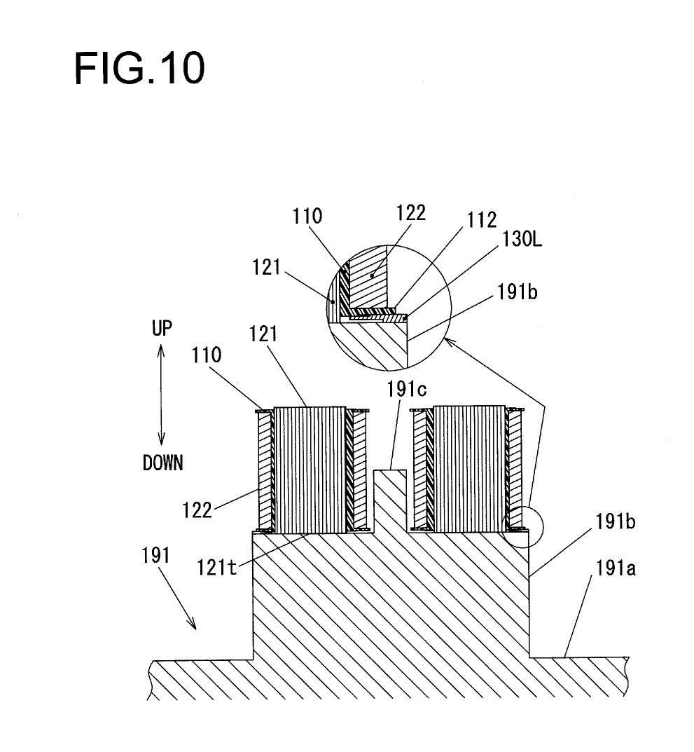

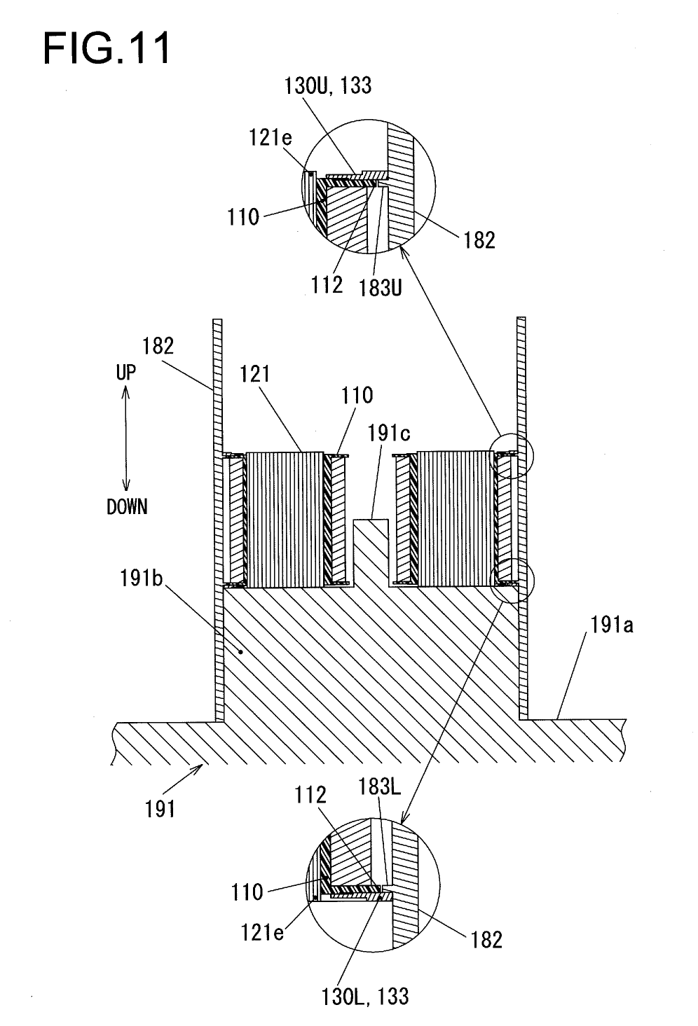

FIG. 10 is a schematic cross sectional figure for explanation of the process of positioning the lower conductive ring 130L and the cores 121, and FIG. 11 is a schematic cross sectional figure for explanation of the process of positioning the center housing 182 and the upper conductive ring 130U. FIGS. 10 and 11 show in outline cross sections in which each of the members is cut through by planes along the axial direction that include the central axis of the rotation shaft 188. In the following, the vertical direction is specified as shown in these figures.

### —the Lower Conductive Ring Positioning Process—

In the process S151 of positioning one of the pair of conductive rings 130 (this one hereinafter will be referred to as the lower conductive ring 130L), as shown in FIG. 10, the lower conductive ring 130L is disposed upon a lower mold 191, which constitutes a lower die. This lower mold 191 comprises a main block 191a, a first circular cylindrical portion 191b that extends vertically upward from the main block 191a, and a second circular cylindrical portion 191c that extends vertically upward from the central portion of the first circular cylindrical portion 191b. The cross sections of both the first circular cylindrical portion 191b and the second circular cylindrical portion 191c are circular. The diameter of the first circular cylindrical portion 191b is set to a dimension that is approximately the same as the internal diameter of the center housing 182. And the diameter of the second circular cylindrical portion 191c is set to a dimension that is slightly larger than the diameter of the rotation shaft 188. The upper surfaces of the first circular cylindrical portion 191b, the second circular cylindrical portion 191c, and the main block 191a are made as flat surfaces, and the lower conductive ring 130L is disposed upon the upper surface of the first circular cylindrical portion 191b.

### —the Core Positioning Process—

In the core positioning process S153 (refer to FIG. 9), twelve of the cores 121 are arranged upon the upper surface of the first circular cylindrical portion 191b so that their lead wires (not shown in the figures) are oriented upward. The lower end surfaces 121t of the cores 121 are contacted against the upper surface of the first circular cylindrical portion 191b, and the flange portions 112 of the bobbins 110 are contacted against the lower conductive ring 130L. Although this feature is not shown in the figure, the respective end portions 161e, 162e of the conductive bars 161, 162 are arranged between the flange portions 112 of the bobbins 110 and the inner circumferential portion 132 of the lower conductive ring 130L. The plurality of cores 121 are arranged at regular intervals in the circumferential direction, so that the directions of lamination of the pluralities of thin magnetic plates 121a that make up the cores 121 extend in radial directions. It should be understood that it is simple and easy to perform positioning of the cores 121 by fitting the pins 115 of the bobbins 110 that are installed in each of the cores 121 into the fitting holes 135 of the lower conductive ring 130L. The lower conductive ring 130L is arranged radially outward of the projecting end portions 121e of the cores 121.

### —the Main Housing Positioning Process—

In the center housing positioning process S155 (refer to FIG. 9), as shown in FIG. 11, the opening at the lower end of the center housing 182 is fitted over the first circular cylindrical portion 191b, so that one end surface of the center housing 182 is contacted against the upper surface of the main block 191a. A plate shaped upper support projection 183U and a plate shaped lower support projection 183L are provided to the center housing 182 so as to project from its inner surface. As seen along the axial direction, the upper support projection 183U and the lower support projection 183L are formed as circular annuluses. The upper support projection 183U and the lower support projection 183L are arranged with a predetermined gap between them that corresponds to the dimension of the bobbins 110 in the axial direction. The lower support projection 183L of the main housing 182 is contacted against the lower conductive ring 130L outward of the flange portions 112 of the bobbins 110 in the radial direction.

### —the Upper Conductive Ring Positioning Process—

In the process S157 of positioning the other of the pair of conductive rings 130 (this one will hereinafter be referred to as the upper conductive ring 130U) (refer to FIG. 9), this upper conductive ring 130U is arranged radially outward of the projecting end portions 121e of the cores 121. The upper conductive ring 130U is pressed in from the opening at the upper end of the center housing 182, and the base portion 133 of this upper conductive ring 130U is mounted upon the flange portions 112 provided at the upper ends of the bobbins 110 that are installed in the cores 121, and upon the upper support projection 183U. Although this feature is not shown in the figure, the end portions 161e, 162e of the conductive bars 161, 162 are arranged between the flange portions 112 of the bobbins 110 and the inner circumferential portion 132 of the upper conductive ring 130U.

It should be understood that it is simple and easy to perform positioning of the upper conductive ring 130U with respect to the cores 121 by fitting the pins 115 of the bobbins 110 into the fitting holes 135 of the upper conductive ring 130U. The upper conductive ring 130U is positioned in the axial direction with respect to the center housing 182 by contacting the upper conductive ring 130U against the upper support projection 183U of the center housing 182.

The base portion 133 of the upper conductive ring 130U is contacted against the inner surface of the center housing 182. In concrete terms, the external peripheral side surface of the circular annular base portion 133 is contacted against the inner peripheral surface of the center housing 182, and the lower surface of the base portion 133 is contacted against the upper surface of the upper support projection 183U.

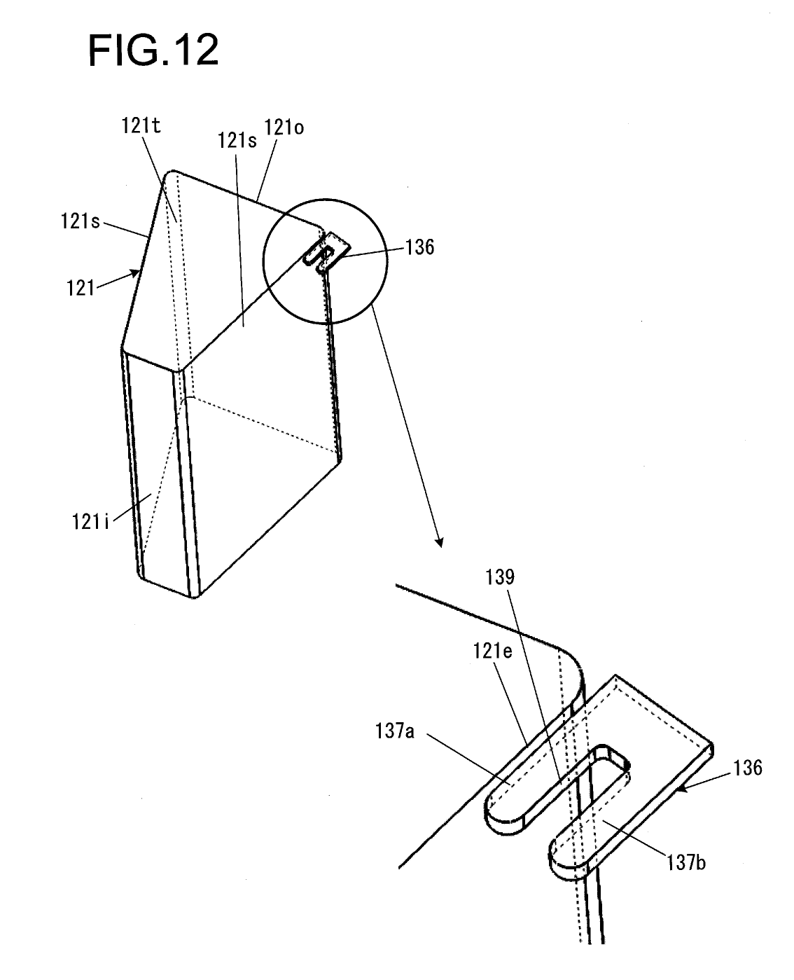

FIG. 12 is a figure showing the state before the projecting portions 136 of one of the conductive rings 130 are bent. When performing positioning of the upper conductive ring 130U as shown in FIG. 11, the projecting portion 136 is arranged on the side in the circumferential direction of the projecting end portion 121e of the core 121 that projects from the top of the bobbin 110, in other words between neighboring ones of the cores 121, as shown in FIG. 12.

### —the Bending Process—

In the bending process S160 (refer to FIG. 8), the ones of the pairs of projecting prongs 137 that are closest to the cores 121 (hereinafter termed bent prongs 137a) are bent toward the cores 121, so that these bent prongs 137a contact the side surfaces 121s of the cores 121.

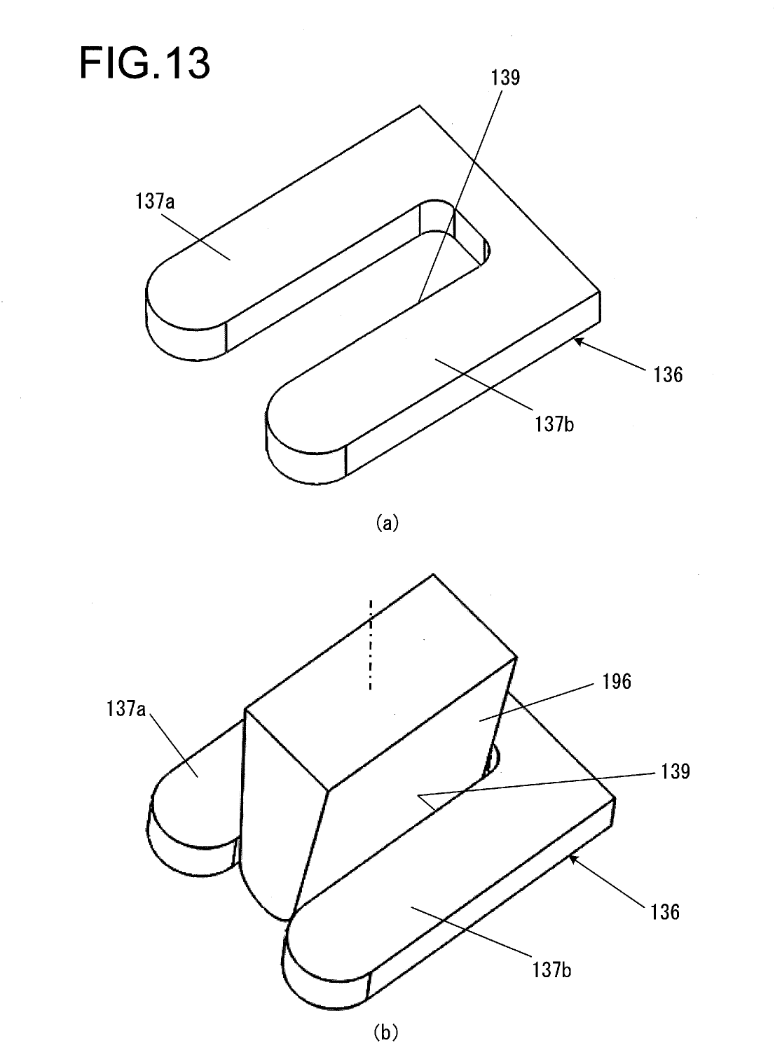

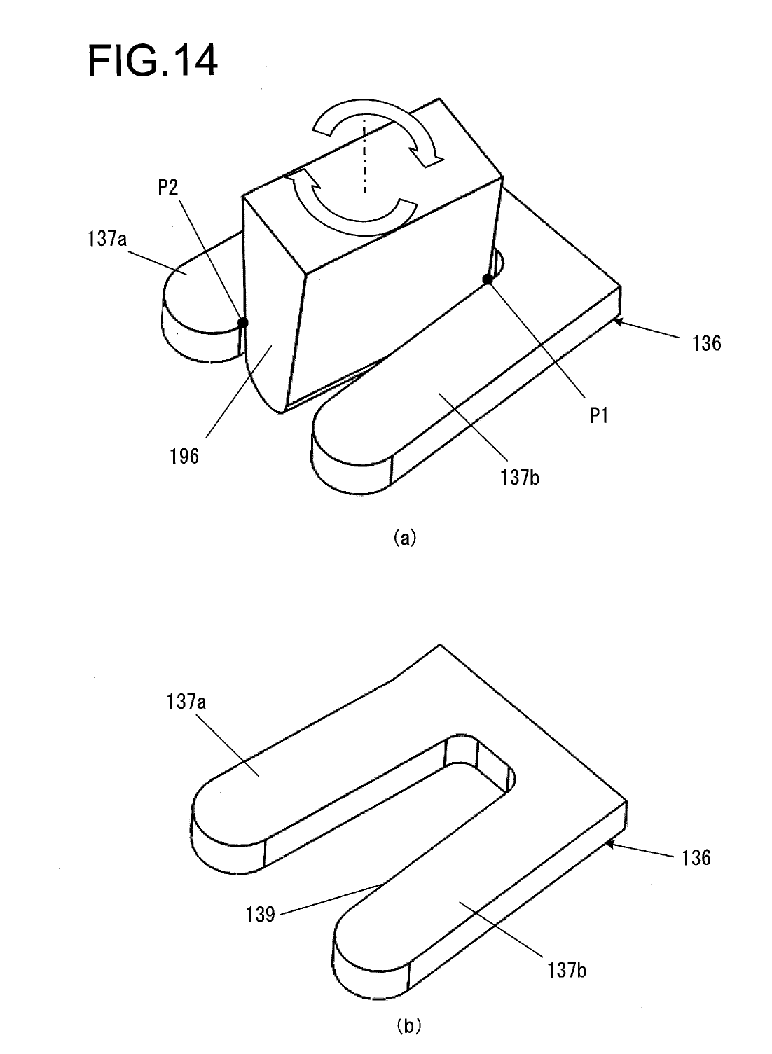

FIG. 13 shows figures for explanation of a process of inserting a bending tool 196 into the slot 139 of the projecting portion 136 of the conductive ring 130, and FIG. 14 shows figures for explanation of a process of bending the bent prong 137a by rotating this bending tool 196 that has been inserted into the slot 139. In FIGS. 13 and 14, the projecting portion 136 is shown as enlarged. As shown in FIGS. 13(a) and 13(b), a tip end portion of the flat plate shaped bending tool 196, for example a flat screwdriver, is inserted into the slot 139 of the projecting portion 136.

As shown in FIG. 14(a), while contacting one edge of the bending tool 196 against the one of the pair of projecting prongs 137 that is remote from the core 121 (hereinafter this will be termed a “support prong 137b”), the bending tool 196 is rotated, so that the opposite edge of the bending tool 196 approaches toward the core 121. As shown in the figure, this one edge of the bending tool 196 contacts against the point P1 at the base end of the resisting prong 137b. And the opposite edge of the bending tool 196 contacts against the point P2 at the tip end of the bent prong 137a.

Forces of the same order act from the bending tool 196, both on the position P1 upon the support prong 137b, and on the position P2 upon the bent prong 137a. The magnitude relationship between the length from the base end portion of the support prong 137b to the position P1 that is the point of operation on the support prong 137b, in other words the length L1 of this moment arm, and the length from the base end portion of the bent prong 137a to the point P2 on the bent prong 137a, in other words the length L2 of this moment arm, is that L2>L1. Accordingly, the bending moment that acts upon the bent prong 137a is greater than the bending moment that acts upon the support prong 137b. Due to this, it is possible for the support prong 137b not to be deformed, while the bent prong 137a is bent toward the side surface 121s of the core 121. It should be understood that while, in this embodiment, the support prong 137b has a projecting length that is approximately the same as that of the bent prong 137a, it will be sufficient if the length of the support prong 137b is adequate to support the one end of the bending tool 196 at the point P1 while the bent prong 137a is being bent.

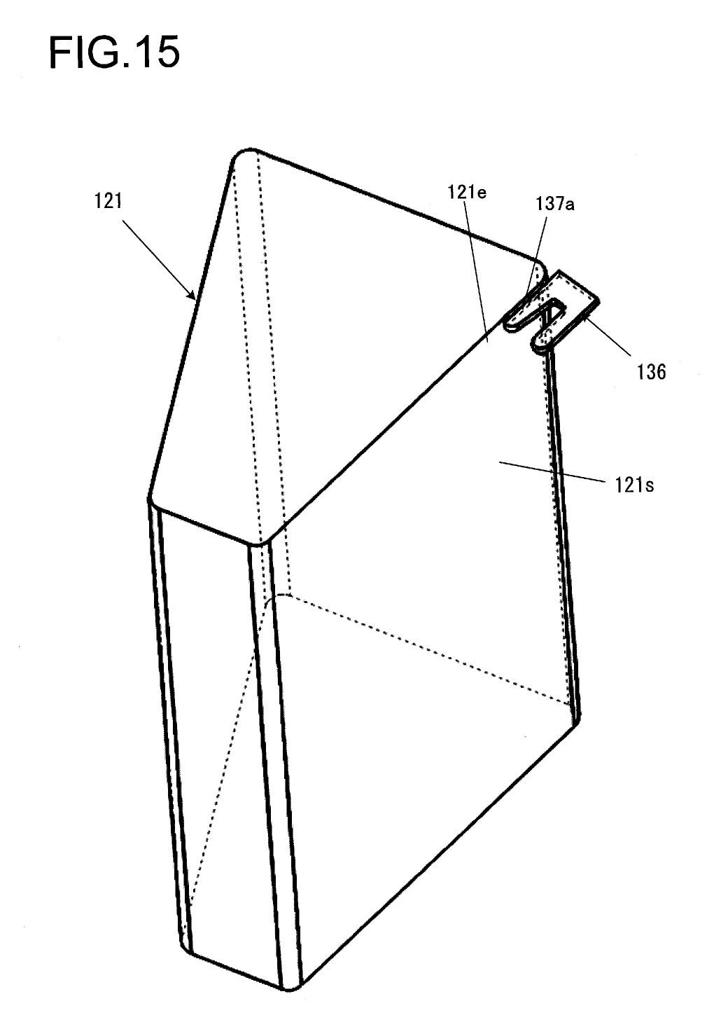

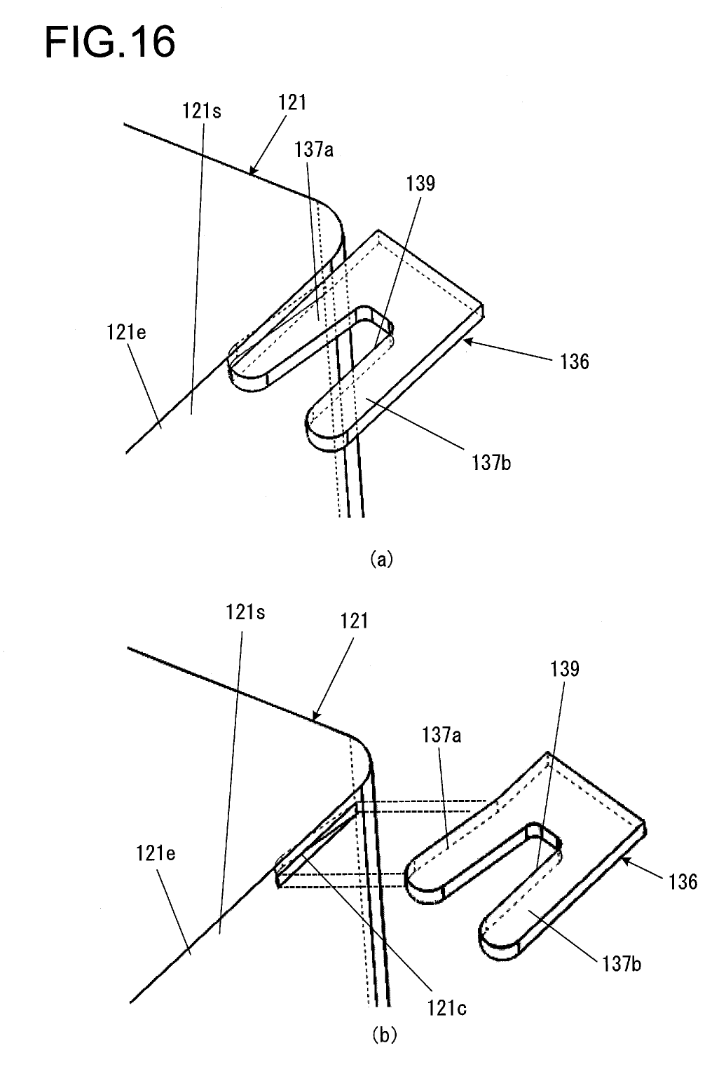

As shown in FIG. 14(b), when the bent prong 137a has been bent through a predetermined angle, then a portion of this bent prong 137a is pressed against the side surface 121s of the core 121, as shown in FIG. 15. FIG. 15 is a figure for explanation of this state in which the bent prong 137a has been pressed against the side surface 121s of the core 121. FIG. 16(a) is an enlarged view of a portion of FIG. 15, while FIG. 16(b) is a figure for explanation of a portion of the side surface 121s of the core 121 that has been deformed. As shown in FIGS. 15 and 16(a), when the bent prong 137a has been bent, a side portion of the bent prong 137a bites into the core 121. As a result, as shown in FIG. 16(b), a concave portion 121c is formed where the side surface 121s of the core 121 has been dug into. The contact area between the bent prong 137a and the core 121 corresponds to the entire area of the inner surface of this concave portion 121c. Due to this the contact area becomes larger, as compared to a case in which the bent prong 137a does not bite into the core 121, but only contacts against the side surface 121s.

### —the Molding Process—

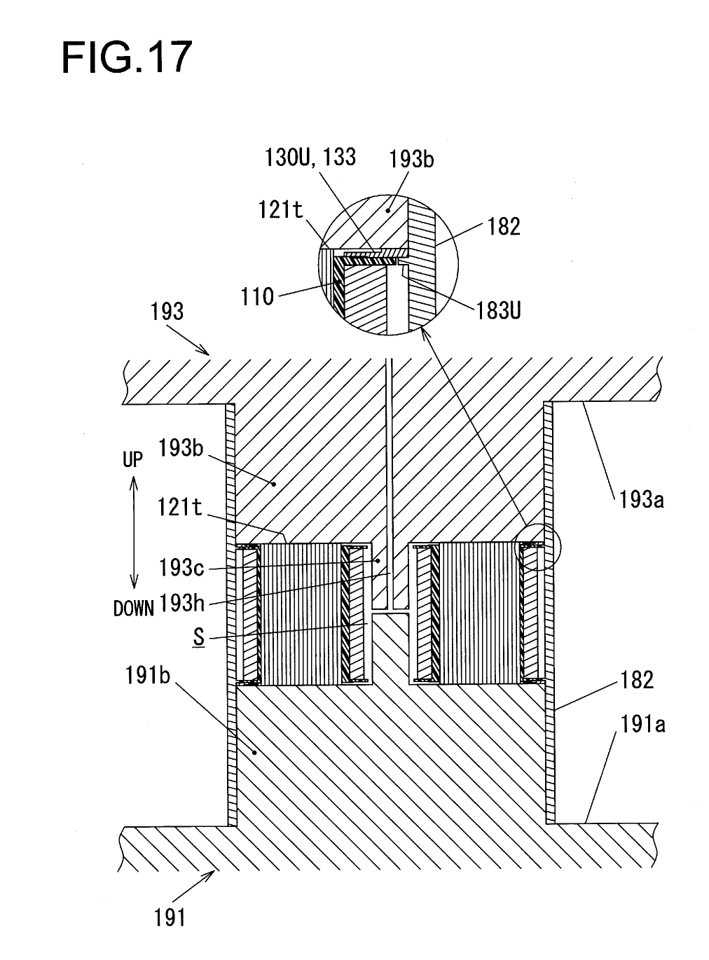

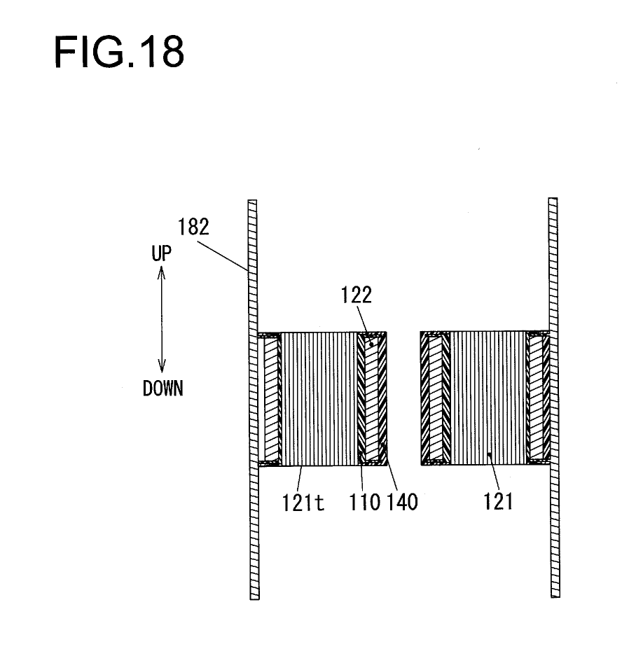

In the molding process S170 (refer to FIG. 8), the plurality of cores 121 are integrally molded together with an insulating resin, so that the side surfaces 121s of the projecting end portions 121e of the cores 121 are covered along with the projecting portions 136 of the conductive rings 130. FIG. 17 is a schematic cross sectional figure showing the way in which a resin charging space is defined by the lower mold 191 and an upper mold 193, and FIG. 18 is a schematic cross sectional figure showing the state in which the plurality of cores 121 have been integrally molded together. FIGS. 17 and 18 are taken in planes along the axial direction that include the central axis of the rotation shaft 188, and show in outline cross sections in which each of the members is cut through. In the following, the vertical direction is specified as shown in these figures.

The upper mold 193, which constitutes an upper die, can be raised and lowered in the vertical direction, and comprises a main block 193a, a first circular cylindrical portion 193b that extends vertically from the main block 193a, and a second circular cylindrical portion 193c that extends vertically from the first circular cylindrical portion 193b. The diameter of the first circular cylindrical portion 193b is the same as the diameter of the first circular cylindrical portion 191b of the lower mold 191. In other words, the diameter of the first circular cylindrical portion 193b of the upper mold 193 is set to have approximately the same dimension as the internal diameter of the center housing 182. And the diameter of the second circular cylindrical portion 193c is the same as the diameter of the second circular cylindrical portion 191c of the lower mold 191. In other words, the diameter of the second circular cylindrical portion 193c of the upper mold 193 is set to be slightly larger than the diameter of the rotation shaft 188. The lower surfaces of the first circular cylindrical portion 193b, the second circular cylindrical portion 193c, and the main block 193a are formed as flat surfaces.

When the upper mold 193 is lowered to a predetermined position, the outer circumferential portion 131 of the base portion 133 of the upper conductive ring 130U and the end surfaces 121t of the cores 121 are contacted against the lower surface of the first circular cylindrical portion 193b. And the upper end surface of the center housing 182 is contacted against the lower surface of the main block 193a. Moreover, the lower surface of the second circular cylindrical portion 193c is disposed to face the upper surface of the second circular cylindrical portion 191c of the lower mold 191. A predetermined gap is created between the second circular cylindrical portion 193c of the upper mold 193 and the second circular cylindrical portion 191c of the lower mold 191, and this constitutes a flow conduit for resin to pass through.

Resin having good fluidity and good insulating characteristic is injected from an injection hole 193h that is provided in the upper mold 193 into a space S for resin charging that is surrounded by the lower mold 191, the upper mold 193, and the center housing 182, so that resin is charged into this space S. Thereafter, when the resin has hardened, the molded body 140 shown in FIGS. 18 and 1 is created.

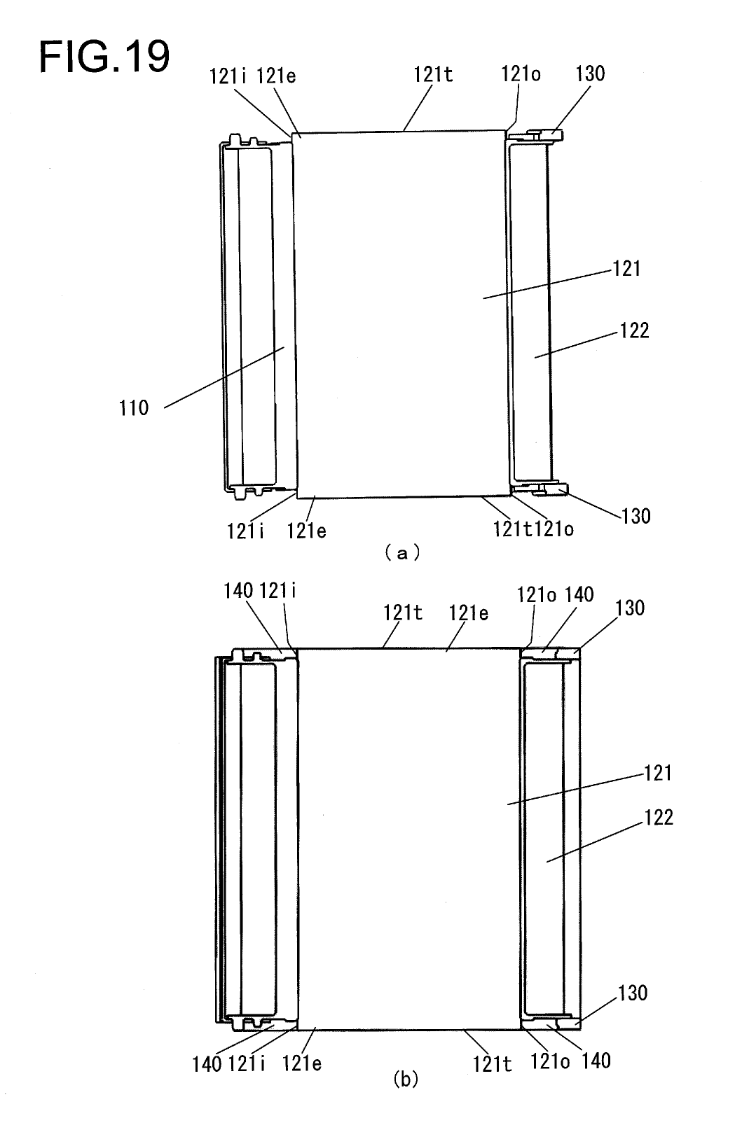

FIG. 19 shows figures showing the relationship between one of the cores 121 and the molded body 140. FIG. 19(a) is a figure showing the state before molding, and corresponds to a schematic cross sectional figure sectioned along the line XIX-XIX in FIG. 1 by a plane that is parallel to the axial direction. And FIG. 19(b) is a figure showing the state after molding, and corresponds to a schematic cross sectional figure sectioned along the line XIX-XIX in FIG. 2 by a plane that is parallel to the axial direction.

As shown in FIG. 19(a), before molding, the projecting end portions 121e of the core 121 are exposed. And, as shown in FIG. 19(b), after molding, the outer surface of the projecting end portion 121e is covered over by the molded body 140, with the exception of its end surfaces 121t. To put this in another manner, the pair of side surfaces 121s, the inner surface 121i, and the outer surface 121o of each of the projecting end portions 121e are covered over by the molded body 140, while their end surfaces 121t are left exposed.

### —the Rotor Assembly Process—

In the rotor assembly process S180 (refer to FIG. 8), the rotation shaft 188, to which one of the rotors 150 has been fitted, is installed in the bearing 186 of one of the housing end members 181. This one rotor 150 is disposed to face the one end surface of the stator 120 in the axial direction, the aperture at one end of the center housing 182 is closed by this one housing end member 181, and this one housing end member 181 is adhered to the center housing 182. Then the other rotor 150 is installed to the rotation shaft 188, so as to sandwich the stator 120 against the one rotor 150 that was previously installed.

### —the Lead Connection Process—

In the lead connection process S190 (refer to FIG. 8), the lead wires of the cores 121 are connected to conductive members for lead connection not shown in the figures. For example, the leads of the coils 122 installed to a plurality of cores 121 may be connected in a star configuration. Circular annular conductive members for lead connection corresponding to each of the U phase, the V phase, and the W phase (hereinafter respectively referred to as the U phase lead connection ring, the V phase lead connection ring, and the W phase lead connection ring) and a circular annular conductive member for lead connection that constitutes a neutral point (hereinafter referred to as the neutral point lead connection ring) are arranged in predetermined positions between the rotors 150 and the housing end members 181 and held by insulating support members or the like (not shown in the figures).

For each of the plurality of coils 122 that are the coils for the U phase, one end thereof is connected to the U phase lead connection ring, while the other end thereof is connected to the neutral point lead connection ring. And for each of the plurality of coils 122 that are the coils for the V phase, one end thereof is connected to the V phase lead connection ring, while the other end thereof is connected to the neutral point lead connection ring. Moreover, for each of the plurality of coils 122 that are the coils for the W phase, one end thereof is connected to the W phase lead connection ring, while the other end thereof is connected to the neutral point lead connection ring. It should be understood that the positions where the lead connection rings are installed are not limited to being located between the rotors 150 and the housing end members 181. For example, it would be acceptable to dispose the neutral point lead connection ring above the flange portions 112 of the bobbins 110. In this case, the process of connecting the lead wires of the coils 122 to this neutral point lead connection ring would be performed during the positioning process S150, or the like.

### —the Closing Process—

In the closing process S195 (refer to FIG. 8), the other housing end member 181 is installed to the rotation shaft 188 via its bearing 186. The aperture at the other end of the center housing 182 is closed by this other housing end member 181, and this other housing end member 181 is adhered to the center housing 182. The rotating electrical machine 100 is completed by the above procedures.

The stator 120 of the rotating electrical machine 100 that has been manufactured in this manner comprises the plurality of cores 121 that are disposed in the circumferential direction of the rotation shaft 188, the bobbins 110 that hold the cores 121, the coils 122 that are wound upon the bobbins 110, the conductive bars 161, 162 for shielding electrostatic coupling between the coils 122 and the rotors 150, and the conductive rings 130 that electrically connect together the side surfaces 121s, which are the end surfaces of the cores 121 in the circumferential direction, and the housing 180.

According to the first embodiment of the present invention described above, the following advantageous operational effects may be obtained.

(1) The cores 121 and the housing 180 are electrically connected together by the conductive rings 130. Accordingly, the cores 121 are grounded to the housing 180, so that it is possible to prevent the cores 121 from developing floating potential. And moreover it is possible to keep the stator 120, the housing 180, and the rotation shaft 188 of the rotors 150 that is held in the housing 180 via the bearings 186 that are provided to the housing 180 all at the same electrical potential, so that it is possible to prevent the development of stray current corrosion of the bearings 186.

(2) The conductive bars 161, 162 are received in the groove portions 118 of the flange portions 112. Due to this, electrostatic coupling of common mode voltage from the coils 122 to the rotors 150 is shielded by the conductive bars 161, 162. As a result, the induction of common mode voltage in the rotors 150 is reduced and the voltage that is applied between the inner rings and the outer rings of the bearings 186 that support the rotors 150 is reduced, so that development of stray current corrosion of the bearings 186 is effectively suppressed.

Moreover, by the conductive bars 161, 162 being received in the groove portions 118, it is possible to perform positioning thereof between the rotors 150 and the coils 122 in predetermined positions in a simple and easy manner.

And, since the conductive bars 161, 162 are received in the groove portions 118, accordingly deviation of the positions of the conductive bars 161, 162 is prevented, even if formation pressure acts upon the conductive bars 161, 162 during the molding process. As a result, it is possible to fix the conductive bars 161, 162 in their predetermined positions, so that it is possible for shielding to be reliably performed by the conductive bars 161, 162.

(3) The conductive bars 161, 162 are sandwiched between the flange portions 112 of the bobbins 110 and the conductive rings 130. Due to this, it is possible to prevent positional deviation of the conductive bars 161, 162 more reliably. Moreover, since there is electrical continuity between the conductive bars 161, 162 and the housing 180 via the conductive rings 130, accordingly the conductive bars 161, 162 are grounded to the housing 180, and it is possible to prevent the conductive bars 161, 162 from developing floating potential.

(4) The cores 121 are made of pluralities of thin magnetic plates 121a laminated together in the radial direction of the rotation shaft 188. And the conductive rings 130 are electrically connected to the housing 180 and to the side surfaces 121s of the cores 121, in other words to the end surfaces of the cores 121 in the circumferential direction. Due to this, there is no influence by the radial dimensions of the cores 121 that are made by laminating together the thin magnetic plates 121a in the radial direction, in other words by the dimensional accuracy in the direction of lamination.

For example, in a case in which the housing 180 and the outer surfaces 121o of the cores 121 are electrically connected together by conductive members, if the dimension of one of the cores 121 in the radial direction is a little shorter than its design value, then the corresponding conductive member and that core 121 may not contact one another.

Contrariwise, in such a case in which the housing 180 and the outer surfaces 121o of the cores 121 are electrically connected together by conductive members, if the dimension of one of the cores 121 in the radial direction is a little longer than its design value, then the corresponding conductive member may be pinched and compressed between the core 121 and the housing 180, so that the conductive member may be deformed.

Due to this, if the housing 180 and the outer surfaces 121o of the cores 121 are to be electrically connected together by conductive members, it is necessary to regulate the dimensional tolerances between the outer surfaces 121o of the cores 121 and the inner surface of the housing 180 minutely, and similarly it is necessary to regulate the dimensional tolerance of the direction of lamination of the cores 121 minutely.

In particular, in this embodiment, the thin magnetic plates 121a of which the cores 121 are composed are made from amorphous foil strip, and their thickness (for example around 0.3 mm) is thin as compared to the thickness of magnetic steel sheet (for example around 0.5 mm), so that the number of laminations becomes great as compared to what would be the case if magnetic steel sheet were employed. As a result, if the cores 121 are formed from thin magnetic plates 121a made from an amorphous metallic material, then, due to the fact that the dimensional tolerance increases cumulatively, uneven variation of the dimension in the direction of lamination, in other words of the dimension in the radial direction, can easily occur, as compared to the case of a core that is made as a lamination of magnetic steel sheets.

However since, in this embodiment, it is arranged to contact the projecting portions 136 of the conductive rings 130 to the end surfaces of the cores 121 in the circumferential direction, accordingly there is no influence by the dimensional accuracy of dimensions of the cores 121 in the radial direction. According to this embodiment, no undesirable forces act upon the conductive rings 130, so that it is possible reliably electrically to connect together the housing 180 and the cores 121. And, since the dimensional tolerances are relaxed as compared to the case in which the outer surfaces 121o of the cores 121 are contacted against conductive members, accordingly the manufacture is simple and easy.

(5) The slots 139 are provided in the projecting portions 136 and extend from the ends of the projecting portions 136 in directions radially outward from the rotation shaft 188. Due to this, it is possible to bend the bent prongs 137a of the projecting portions 136 simply and easily by inserting the bending tool 196 into the slots 139 and by rotating it, so that it is possible to anticipate enhancement of the working efficiency.

(6) The pair of pins 115 for positioning are provided upon the flange portion 112 of the bobbin 110, and the pair of fitting holes 135 into which these pins 115 are inserted are provided upon the conductive ring 130. By fitting the pins 115 into the fitting holes 135, it is simple and easy to perform positioning of the conductive ring 130. And accordingly, due to the workability being enhanced, it is possible to anticipate that the man-hours required for manufacture will be reduced.

(7) Since the pair of pins 115 and the pair of fitting holes 135 are engaged together, accordingly the occurrence of positional deviation or deformation of the conductive ring 130 when the bending tool 196 is rotated can be prevented, and it is possible to enhance the workability for bending the bent prong 137a.

(8) The thin magnetic plates 121a that make up the cores 121 are made from an amorphous metallic material. Due to this, it is possible to reduce the energy losses (i.e. the losses due to hysteresis), as compared to the case of cores 121 that are made from, for example, magnetic steel sheet.

As described above, the thickness of the thin magnetic plates 121a that make up the cores 121 (for example 0.3 mm) is thinner, as compared to the thickness of magnetic steel sheet (for example 0.5 mm). Due to this, as compared to cores made from magnetic steel sheet, the cores 121 of this embodiment can easily be deformed when force acts upon their side surfaces 121s. Because of this, it is possible for the bent prongs 137a to bite into the side surfaces 121s of the cores 121 during the bending process S160. And since, as a result, it is possible to enhance the strength of the connections and moreover to increase the contact areas between the bent prongs 137a and the cores 121, accordingly it is possible to reduce the electrical resistance.

(9) Since the conductive rings 130 contact both the cores 121 and the center housing 182, accordingly heat generated in the cores 121 is transmitted to the center housing 182 via the conductive rings 130 And this heat that has been transmitted to the center housing 182 is dissipated to the external atmosphere. In other words, the conductive rings 130 also serve the function of transmitting heat from the cores 121 to the housing 180, so that it is possible to anticipate enhancement of the performance for cooling.

It should be understood that, since this heat is transmitted to the housing 180 by the conductive rings 130 with good efficiency, accordingly it will be effective to make the volumes of the conductive rings 130 great, in other words to make their thermal capacities great. However, if their volumes become great, the losses due to eddy currents also become great. Thus, in this embodiment, it is possible to reduce the losses due to eddy currents by changing the thickness of the base portions 133 as in (10) through (12) below and by forming the plurality of slits 134, and accordingly enhancement of the efficiency of this motor may be anticipated.

(10) Since the inner circumferential portions 132 of the conductive rings 130 are closer to the cores 121 as compared to their outer circumferential portions 131, accordingly the influence of eddy currents upon them is greater. Thus, in this embodiment, since the thickness of the inner circumferential portions 132 (for example around 1 mm) of the conductive rings 130 is thinner than the thickness of the outer circumferential portions 131 (for example around 3 mm), accordingly it is possible to reduce losses due to eddy currents in the inner circumferential portions 132.

(11) The plurality of slits 134 are provided in the inner circumferential portions 132 of the base portions 133 so as to extend outward in the radial direction from their inner circumferential edge. Since the paths of eddy currents are intercepted by these slits 134, accordingly it is possible to reduce losses due to eddy currents, as compared to the case when these slits 134 are not provided.

(12) The slots 139 are provided in the projecting portions 136. Since the paths of eddy currents are intercepted by these slots 139, accordingly it is possible to reduce the losses due to eddy currents, as compared to a case in which no such slots 139 are provided.

(13) Since the outer circumferential portions 131 of the conductive rings 130 are remote from the cores 121 as compared to their inner circumferential portions 132, accordingly the influence of eddy currents therein is small. In this embodiment, as described above, by contrast to the thickness of the inner circumferential portions 132 of the conductive rings 130 (for example around 1 mm), the thickness of the outer circumferential portions 131 is thicker (for example around 3 mm), so that the rigidity of the conductive rings 130 is enhanced. In other words, in this embodiment, the rigidity is enhanced while suppressing increase of the eddy current losses. Due to this, it is possible to prevent deformation of the conductive rings 130 due to clamping force from the main housing 182 acting upon the conductive rings 130 by the conductive rings 130 being pressed into the main housing 182. Furthermore, it is possible to prevent deformation of the base portions 133 when bending the bent prongs 137a with the bending tool 196. It should be understood that the thickness of the bent prongs 137a is the same as the thickness of the inner circumferential portions 132, so that it is possible to bend and deform the bent prongs 137a simply and easily, and the workability is good.

(14) The plurality of cores 121 are integrally molded with an insulating resin, so that the side surfaces 121s of the cores 121, which are their end surfaces in the circumferential direction, are covered along with the projecting portions 136 of the conductive rings 130. The cores 121 can be held with the molded body 140, and moreover it is possible to maintain the connection strength at the electrical connection portions between the cores 121 and the conductive rings 130. As a result, it is possible to provide a rotating electrical machine 100 that is excellent from the standpoints of anti-vibration performance and anti-shock performance.

(15) In the conductive rings 130, the circular annular base portions 133 that contact the inner surface of the housing 180 are formed integrally with the plurality of projecting portions 136 that project from those base portions 133 toward the center of the rotation shaft 188. Due to this, during the positioning process S150, relative positioning of the cores 121 can be performed simply and easily, while preventing the cores 121 from positional deviation in the axial direction and preventing them from tilting. In other words, it is possible to enhance the workability of arranging the conductive rings 130 and the cores 121, as compared to a case in which a plurality of conductive members must be arranged.

### Second Embodiment

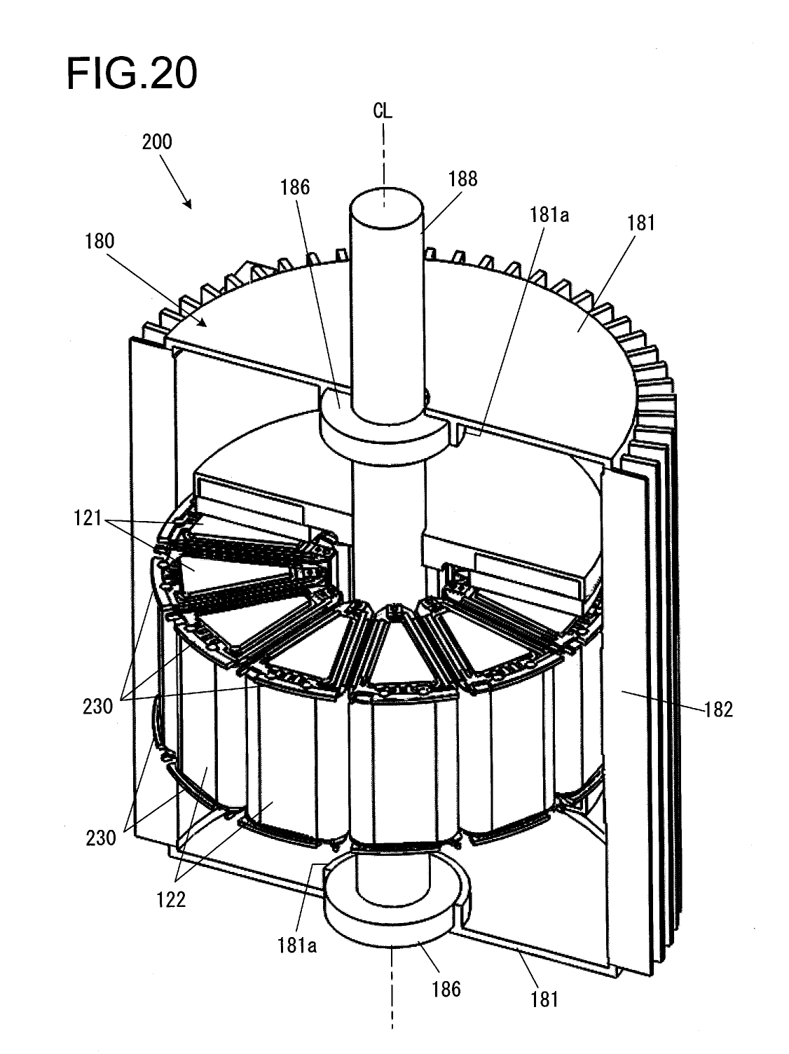

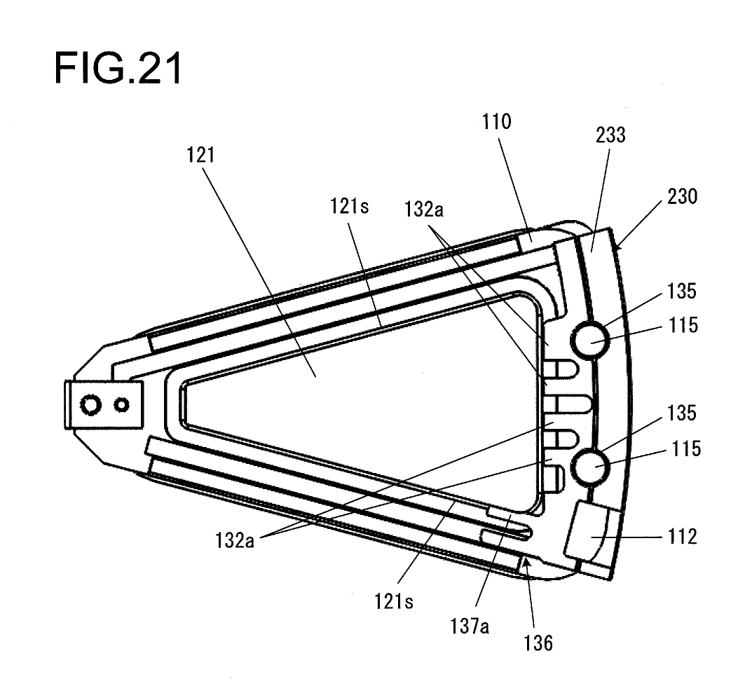

An axial gap type rotating electrical machine according to a second embodiment of the present invention (hereinafter simply termed the “rotating electrical machine 200”) will now be explained with reference to FIGS. 20 and 21. The same reference symbols are appended to elements that are the same as elements in the first embodiment or that correspond thereto, and explanation thereof will be omitted. In the following, the features of difference from the first embodiment will be explained in detail.

FIG. 20 is a cutaway perspective view showing the structure of the axial gap type rotating electrical machine according to this second embodiment, and FIG. 21 is a figure showing one core 121 and one conductive member 230 of FIG. 20 as seen along the axial direction. It should be understood that the molded body 140 is not shown in FIG. 20.

This rotating electrical machine 200 according to the second embodiment has a similar structure to the rotating electrical machine 100 explained in connection with the first embodiment, except for the structure of the conductive members 230. In the conductive rings 130 of the first embodiment, which were the conductive members thereof, the circular annular base portions 133 were formed integrally with the plurality of projecting portions 136 that projected from those base portions 133 (refer to FIG. 6). By contrast, the conductive member 230 of the second embodiment corresponds to one divided portion of the circular annular base portion 133 explained in connection with the first embodiment, and, as shown in FIG. 20, one of these conductive members 230 is installed separately to each of the cores 121.

As shown in FIG. 21, in each conductive member 230, a circular arcuate base portion 233 that contacts the inner surface of the center housing 182 and a single projecting portion 136 that projects from the base portion 233 are provided integrally with one another. It is possible to perform positioning of the conductive member 230 simply and easily by fitting a pair of pins 115 that are provided to extend upward on the flange portion 112 of the bobbin 110 into a pair of fitting holes 135 that are provided in the conductive member 230.

The base portion 233 of the conductive member 230 is contacted against the inner surface of the center housing 182, and the bent prong 137a of the projecting portion 136 is bent with the bending tool 196 (refer to FIGS. 13 and 14), so as to contact against the side surface 121s of the core 121.

According to this second embodiment, in addition to the advantageous operational effects (1) through (15) explained above in connection with the first embodiment, the following further advantageous operational effect is obtained.

(16) The approximately circular annular conductive ring 130 is divided around the circumferential direction, so as to form the plurality of conductive members 230. Since in this second embodiment it is possible to intercept the paths of eddy currents by the surfaces of separation in this manner, accordingly it is possible further to reduce the losses originating in eddy currents, as compared to the approximately circular annular conductive ring 130 explained in connection with the first embodiment. It should be understood that the number of divisions is not limited to the case of corresponding to the number of the cores 121.

### Third Embodiment

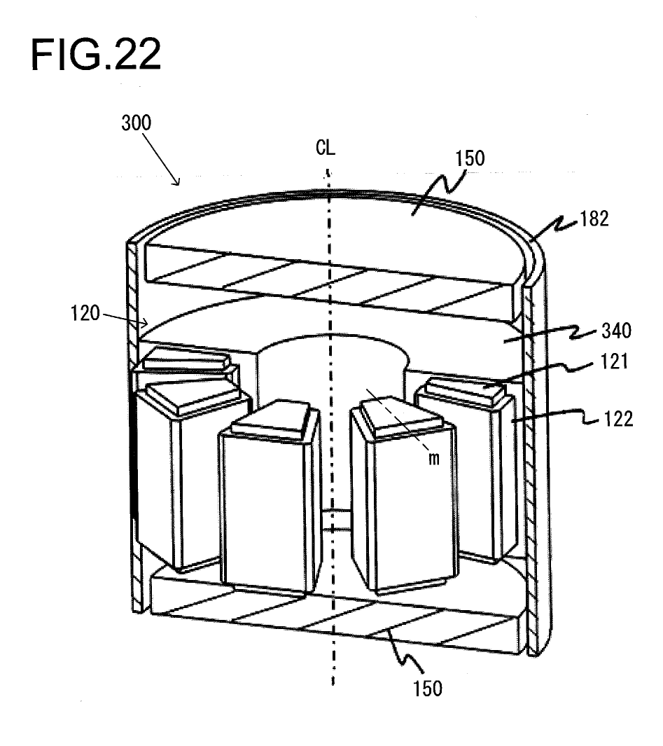

An axial gap type rotating electrical machine according to a third embodiment of the present invention will now be explained with reference to FIGS. 22 through 25. The same reference symbols are appended to portions that are the same as portions in the first embodiment or that correspond thereto, and explanation thereof will be omitted. In the following, the features of difference from the first embodiment will be explained in detail.

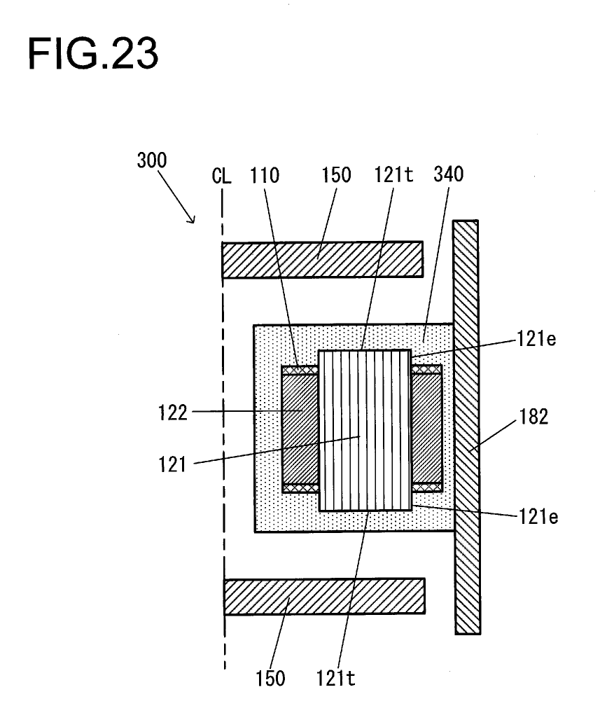

FIG. 22 is a cutaway perspective view showing the structure of this axial gap type rotating electrical machine according to the third embodiment of the present invention (hereinafter simply termed the “rotating electrical machine 300”), and FIG. 23 is a schematic cross sectional figure taken in a plane parallel to the axial direction and including a center line m that divides into two the width in the circumferential direction of a core 121 shown in FIG. 22. It should be understood that, in FIGS. 22 and 23, the conductive rings and conductive bars are omitted. Moreover the rotation shaft is not shown in the figure, while the central axis CL of the rotation shaft is shown.

In the first embodiment, an example was explained in which the end surfaces 121t of the cores 121 were not covered over by the molded body 140, but were exposed. However, if ferrite magnets are employed as the magnets 152 that are installed to the rotors 150 of an axial gap type rotating electrical machine, then it is necessary to increase the diameters of the rotors 150, since the magnetic characteristics are inferior as compared with the case of employing rare earth magnets. As a result, the sizes and the weights of the cores 121 are increased so that it is necessary to enhance the strength with which the stator cores 121 are held. Accordingly, in this third embodiment, the end surfaces 121t of the cores 121 are covered by the molded body 340, so that the strength with which the cores 121 are held is increased.

As a technique for enhancing this holding strength, for example, there is the technique described in Japanese Laid-Open Patent Publication No. 2007-28855 (hereinafter this will be termed the “prior art technique”). In this prior art technique, letter-T shaped cores are inserted into the stator core yokes, these cores are projected from the stator core yokes, and the entire projecting portions are covered with resin. With this prior art technique, convex portions extending in the radial direction are formed on surfaces of the cores that oppose the rotor, and the strength with which the cores are held is increased by covering the cores with resin except for the convex portions. However, the provision of these convex portions upon the cores leads to increase of the number of manufacturing steps, and accordingly is not desirable. Moreover there is also the problem that, if the cores are made by laminating together thin magnetic plates made from amorphous foil strip, then it is difficult to form the convex portions.

The rotating electrical machine according to the third embodiment has a similar structure to the rotating electrical machine of the first embodiment, but the number of the cores 121 and the shapes and dimensions of the structural members are different. In detail, this rotating electrical machine 300 comprises a rotation shaft (not shown in the figures), a pair of rotors 150 that are fixed to the rotation shaft, a stator 120 that is disposed between the pair of rotors 150, and a housing that houses the pair of rotors 150 and the stator 120 (only the center housing 182 is shown in FIGS. 22 and 23).

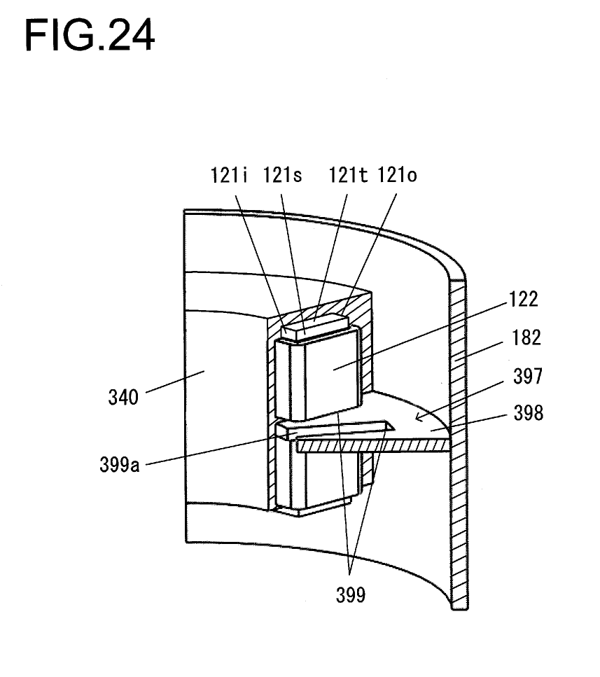

In this third embodiment, before the molding process, the plurality of cores 121 are held in predetermined positions within the center housing 182 by a holding member 397. FIG. 24 is a partly cut away perspective view showing the holding member 397 holding one of the cores 121 during the molding process. The holding member 397 is made from insulating resin, and comprises an external circumferential portion 398 which is a circular annulus and a plurality of sandwiching portions 399 that project from this external circumferential portion 398 toward the center of the rotation shaft.

The holding member 397 is attached by being pressed into the center housing 182 of the housing 180 or by being adhered thereto, so that the external circumferential portion 398 of the holding member 397 is adhered to the inner peripheral surface of the center housing 182. And a plurality of the sandwiching portions 399 are provided at predetermined intervals along the circumferential direction. An opening portion 399a is provided between two sandwiching portions 399 adjacent to one another in the circumferential direction, into which a core 121 and its bobbin (not shown in the figures) are pressed. Although this feature is not shown in the figures, it should be understood that a plurality of through holes are provided in the external circumferential portion 398 of the holding member 397, and these through holes extend in the axial direction, thus constituting flow conduits for the resin in the fluid state during molding.

The coils 122 are wound above and below the sandwiching portions 399 so as to avoid the sandwiching portions 399. Each of the cores 121 is attached by being pressed into one of the opening portions 399a, and is sandwiched by a pair of sandwiching portions 399 that are adjacent in the circumferential direction. It should be understood that, in this embodiment, in order for the cores to be pressed into the opening portions 399a, the holding member 397 is made from a resin material that has moderate flexibility and is elastically deformable, and the difference between the length of the upper base and the length of the lower base in the trapezoidal cross section of the approximately trapezoidal prism shaped cores 121 is set to be small. Moreover, it should be understood that it would also be acceptable to arrange for the cores 121 to be approximately shaped as rectangular parallelepipeds, instead of being approximately shaped as trapezoidal prisms.

As shown in FIG. 17, in the first embodiment, in the molding process, the resin was charged in the state in which the upper surface of the first circular cylindrical portion 191b of the lower mold 191 was contacted against the lower end surfaces 121t of the cores 121, and the lower surface of the first circular cylindrical portion 193b of the upper mold 193 was contacted against the upper end surfaces 121t of the cores 121.

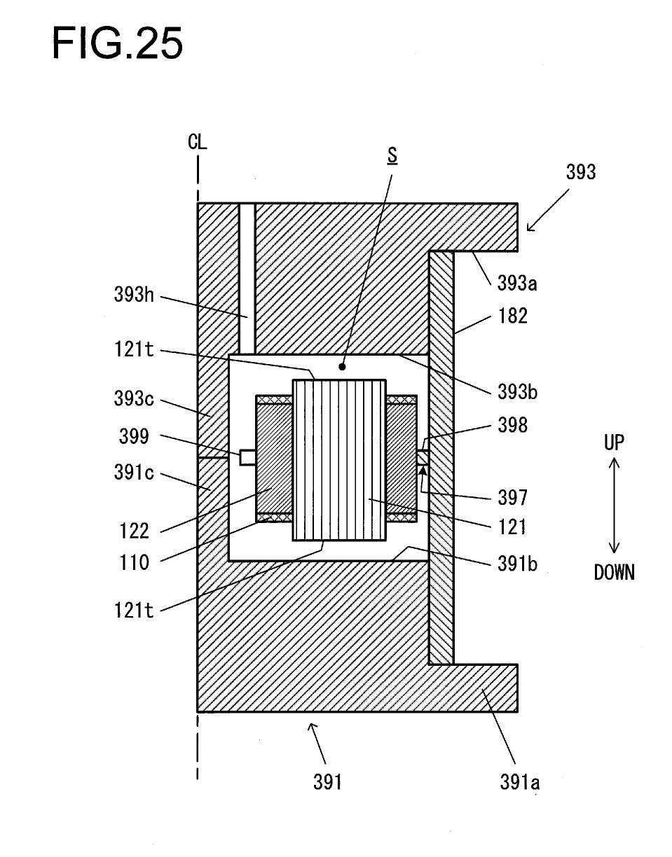

By contrast, in this third embodiment, the resin is charged after a lower mold 391 and an upper mold 393 have been arranged in predetermined positions in the following manner. FIG. 25 is a schematic cross sectional figure showing a state in which a resin charging space is defined by the lower mold 391 and the upper mold 393. FIG. 25 is taken in a plane along the axial direction that includes the central axis of the rotation shaft 188, and shows in outline a cross section in which each of the members is cut through. In the following, the vertical direction is specified as shown in this figure.

As shown in FIG. 25, the lower mold 391 comprises a main block 391a, a first circular cylindrical portion 391b that stands vertically upward from the main block 391a, and a second circular cylindrical portion 391c that extends vertically upward from the central portion of the first circular cylindrical portion 391b. The cross sections of both the first circular cylindrical portion 391b and the second circular cylindrical portion 391c are circular. The diameter of the first circular cylindrical portion 391b is set to a dimension that is approximately the same as the internal diameter of the center housing 182. And the diameter of the second circular cylindrical portion 391c is set to a dimension that is slightly larger than the diameter of the rotation shaft 188. The upper surfaces of the first circular cylindrical portion 191b, the second circular cylindrical portion 191c, and the main block 191a are made as flat surfaces.

The upper mold 393 can be raised and lowered in the vertical direction, and comprises a main block 393a, a first circular cylindrical portion 393b that extends vertically from the main block 393a, and a second circular cylindrical portion 393c that extends vertically from the first circular cylindrical portion 393b. The diameter of the first circular cylindrical portion 393b is the same as the diameter of the first circular cylindrical portion 391b of the lower mold 391. In other words, the diameter of the first circular cylindrical portion 393b of the upper mold 393 is set to have approximately the same dimension as the internal diameter of the center housing 382. And the diameter of the second circular cylindrical portion 393c is the same as the diameter of the second circular cylindrical portion 391c of the lower mold 391. In other words, the diameter of the second circular cylindrical portion 393c of the upper mold 393 is set to be slightly larger than the diameter of the rotation shaft 188. The lower surfaces of the first circular cylindrical portion 393b, the second circular cylindrical portion 393c, and the main block 393a are formed as flat surfaces.

The holding member 397 is adhered to the center housing 182 in advance, and the cores 121 are installed into the holding member 397. Then the opening at the bottom end of the center housing 182 is fitted over the first circular cylindrical portion 391b, so that one end surface of the center housing 182 is contacted against the upper surface of the main block 391a. A gap is created between the upper surface of the first circular cylindrical portion 391b of the lower mold 391 and the lower end surfaces 121t of the cores 121. Then, when the upper mold 393 is lowered down to a predetermined position, the lower surface of its second circular cylindrical portion 393c contacts against the upper surface of the second circular cylindrical portion 391c of the lower mold 391. And a gap is created between the lower surface of the first circular cylindrical portion 393b of the upper mold 393 and the upper end surfaces 121t of the cores 121.

Insulating resin having good fluidity is injected from an injection hole 393h that is provided in the upper mold 393 into a space S for resin charging that is surrounded by the lower mold 391, the upper mold 393, and the main housing 182, and thereby this resin is charged into the space S. Thereafter, when the resin has hardened, a molded body 340 shown in FIGS. 22 through 24 is formed. As shown in FIG. 24, the pair of side surfaces 121s, the inner surfaces 121i, the outer surfaces 121o, and the end surfaces 121t of the projecting end portions 121e of each of the cores 121 are covered by this molded body 340.

According to this third embodiment, in addition to advantageous operational effects similar to those explained above in connection with the first embodiment being obtained, also the following further advantageous operational effects are obtained.

(17) It is arranged to cover over the entire outer surfaces of the projecting end portions 121e of the cores 121 that project from the bobbins 110 with the molded body 340, in other words to cover over their end surfaces 121t and their pairs of side surfaces 121s, their inner surfaces 121i, and their outer surfaces 121o. Due to this, as compared to the case with the first embodiment, it is possible to improve the strength with which the cores 121 are held, and thus it is possible to provide a rotating electrical machine that is excellent from the standpoints of anti-vibration resistance and anti-shock resistance.

Furthermore, it is also possible to prevent the cores 121 from undergoing oxidization reactions due to moisture included in the air within the housing 180. In other words, since it is possible to prevent the generation of rust upon the cores 121, accordingly it is possible to provide a rotating electrical machine that is capable of maintaining its performance as a motor over the long term.

(18) As compared to magnetic steel sheet or the like, the thickness of amorphous foil strip is thinner, and it is harder, which makes it difficult to employ amorphous foil strip for the thin magnetic plates 121a if the core is to be made in a complicated shape as in the prior art. By contrast, the cores 121 can be manufactured simply and easily in this embodiment, since it is possible to form their end surfaces 121t and their side surfaces 121s as simple plane surfaces so as to define the cores 121 as trapezoidal prisms.

(19) It is arranged to cover both the upper projecting end portions 121e and also the lower projecting end portions 121e of the cores 121 with the molded body 340. In other words, since both the end portions in the axial direction of the cores 121 are held by the molded body 340, accordingly it is possible to enhance the strength with which the cores 121 are held, as compared with a case in which only their one end portions are held by the molded body 340.

(20) Since it is possible to enhance the strength with which the cores 121 are held, accordingly it is possible to employ ferrite magnets for the magnets 152 that are installed to the rotor 150. Since, as compared to other magnetic materials, ferrite magnets can be obtained more cheaply and moreover their availability is more stable, accordingly it is possible to anticipate reduction in the cost of the rotating electrical machine 100.

### Variant of Third Embodiment

The third embodiment can also be implemented in the following variant manner.

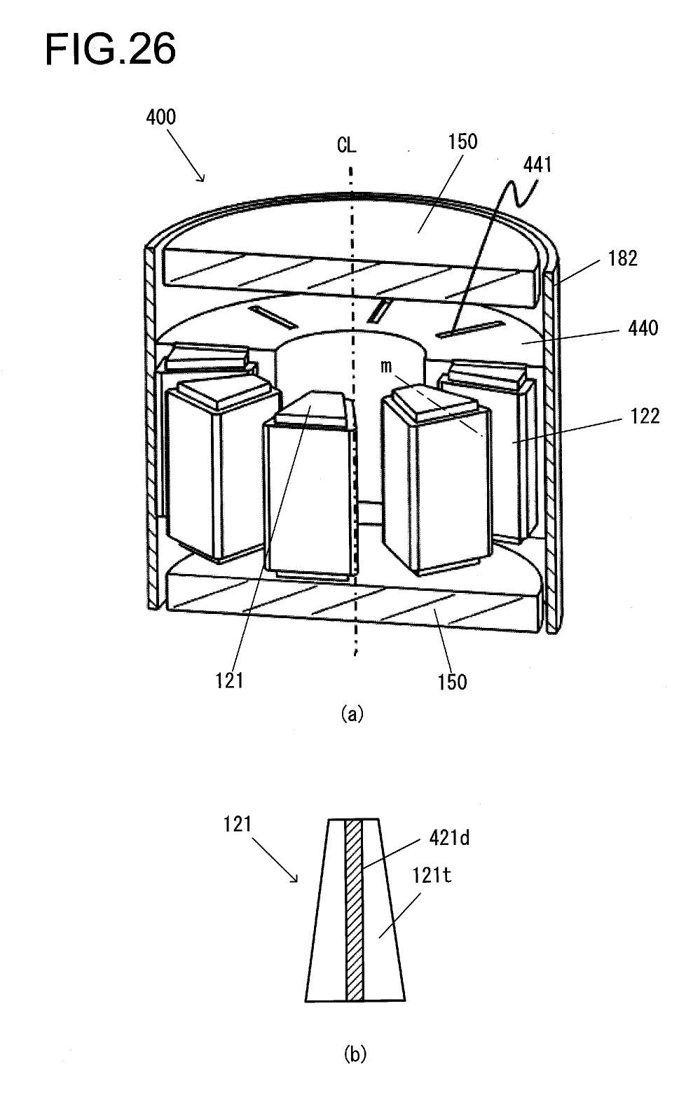

FIG. 26(a) is similar to FIG. 22, and is a cutaway perspective view showing the structure of an axial gap type rotating electrical machine according to a variant of the third embodiment described above. As shown in FIG. 26(a), in this variant of the third embodiment, concave portions 441 are provided in a molded body 440, sunk into the end surfaces 121t of the cores 121. FIG. 26(b) is a figure showing the end surface of one of the cores 121 in the axial direction, in other words showing a die contacting region 421d upon the end surface 121t.

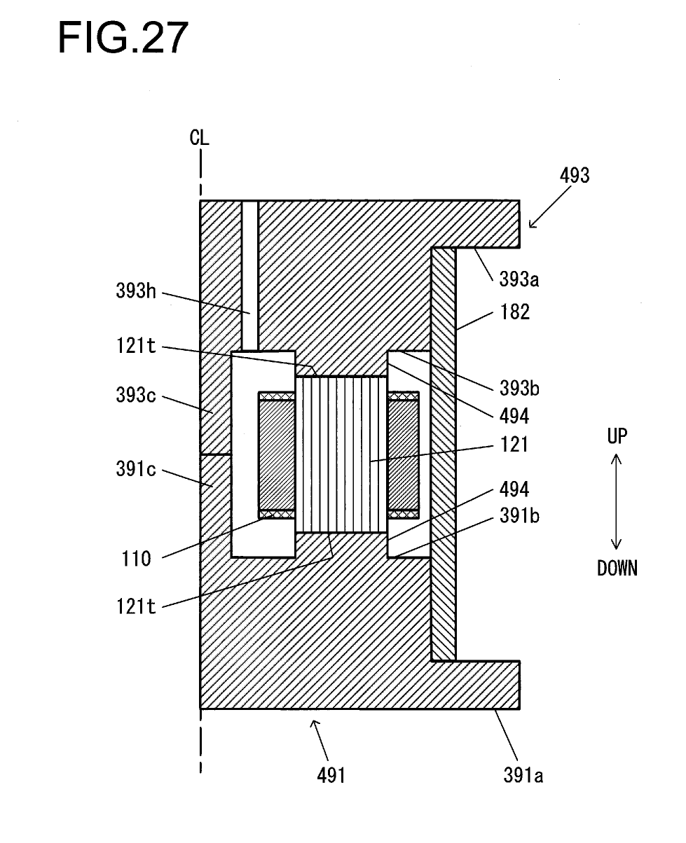

And, as shown in FIG. 26(b), a region that is rectangular in shape and that extends in the radial direction is provided upon the end surface 121t of the core 121, and serves as a die contacting region 421d. FIG. 27 is similar to FIG. 25, and is a schematic cross sectional view showing the way in which a resin charging space is defined by a lower mold 491 and an upper mold 493. The lower mold 491 has a similar structure to that of the lower mold 491 explained in connection with the third embodiment, but is differentiated from the case of the lower mold 391 in that a protruding contact portion 494 that is shaped as a rectangular parallelepiped is provided so as to extend from the upper surface of the first circular cylindrical portion 391b. In a similar manner, the upper mold 493 has a similar structure to that of the upper mold 393 explained in connection with the third embodiment, but is differentiated from the case of the upper mold 393 in that a protruding contact portion 494 that is shaped as a rectangular parallelepiped is provided so as to extend from the lower surface of the first circular cylindrical portion 393b. Two of these protruding contact portions 494 are provided for each of the cores 121.

As shown in FIG. 27, when a resin charging space has been defined by the lower mold 491 and the upper mold 493, the protruding contact portion 494 of the upper mold 493 is contacted against one of the die contacting regions 421d (refer to FIG. 26(b)) of the pair of end surfaces 121t, while the protruding contact portion 494 of the lower mold 491 is contacted against the other one of the die contacting regions 421d (refer to FIG. 26(b)) of the pair of end surfaces 121t.

In this manner, in this variant of the third embodiment, the die contacting region 421d against which the protruding contact portion 494 of the mold is contacted is provided upon each one of the pair of end surfaces 121t. The die contacting regions 421d of each pair of end surfaces 121t are provided in the same position as seen along the axial direction, and moreover are set to be of the same shape. And each of the die contacting regions 421d on each pair of end surfaces 121t is at least set to be upon the same vertical line. For this, during the molding process, each protruding contact portion 494 of the upper mold 493 and the corresponding protruding contact portion 494 of the lower mold 491 are arranged so as mutually to face one another along the same vertical line.

Due to this, it is possible to prevent positional deviation such as tilting of the cores 121 occurring during the molding process, since the cores 121 are sandwiched between the protruding contact portions 494 of the upper mold 493 and the corresponding protruding contact portions 494 of the lower mold 491, along the same vertical lines. And, since it is possible to hold the cores 121 in their proper positions with the molded body 440, accordingly it is possible to provide a rotating electrical machine whose efficiency as a motor is excellent.

Since it is possible to hold the cores 121 with the upper mold 493 and the lower mold 491, accordingly it is possible to omit the holding member 397 that were explained above in connection with the third embodiment.

The following variations are also included within the scope of the present invention, and moreover it is also possible to combine one or more of these variant embodiments with one or more of the embodiments described above.

(1) It would also be acceptable to arrange for the prongs 132a that are provided on the base portion 133 facing the outer surfaces of the cores 121 (refer to FIGS. 3 and 21) and the outer surfaces 121o to be contacted together. Since, by contacting the prongs 132a against the outer surfaces 121o, it would be possible to absorb heat of the cores 121 from the outer surfaces 121o, and it would be possible to transfer this heat to the housing 180, accordingly it would be possible to cool the cores 121 more effectively. It should be understood that if, due to dimensional tolerances in the radial direction, a gap is created between the outer surfaces 121o and the prongs 132a, then it would also be possible to attach a thermally conductive member across the gap, so as thermally to connect together the outer surfaces 121o and the prongs 132a more effectively via these thermally conductive members.

(2) While, in the embodiments described above, examples were explained in which the slots 139 were provided in the projecting portions 136, the present invention should not be considered as being limited to that structure. It would also be acceptable to press projecting portions 136 having no such slots 139 into the side surfaces 121s of the cores 121, so as electrically to connect together the cores 121 and the projecting portions 136.

(3) The present invention should not be considered as being limited to the above described case in which the cores 121 and the projecting portions 136 are contacted together by the projecting portions 136 being bent against the side surfaces 121s of the cores 121. For example, instead of the projecting portions 136 projecting from the base portion 133 toward the center of the rotation shaft 188, the projecting portions 136 may be formed so as to be slightly inclined toward the cores 121. When positioning the conductive ring 130, the projecting portions 136 may be deformed in advance in the directions away from the cores 121 so that the projecting portions 136 contact the cores 121 due to their elastic restoring force after the conductive ring 130 is arranged them in position.

(4) The shapes of the conductive rings 130 and the conductive members 230 are not to be considered as being limited by the embodiments described above. Provided that it is possible electrically to connect together the side surfaces 121s of the cores 121 and the housing 180, it is possible to employ any of various shapes. Furthermore, the shapes of the conductive bars 161, 162 and the shapes of the groove portions 118 in which the conductive bars 161, 162 are received are also not to be considered as being limited by the embodiments described above. While, in the embodiments described above, examples were disclosed in which the cross sectional shapes of the conductive bars 161, 162 were rectangular, it would also be possible for them to be made with various other cross sectional shapes, such as, for example, circular shapes, semicircular shapes, elliptical shapes, polygonal shapes, or the like.

(5) The type of the motor is not to be considered as being limited by the embodiments described above. For example, it would also be acceptable to employ a switched reluctance motor (SR motor) having a rotor provided with a salient pole, instead of the magnets 152.

(6) While, in the embodiments described above, examples of axial gap type rotating electrical machines of the two rotor one stator type were explained, the present invention should not be considered as being limited to that configuration. It would also be possible to apply the present invention to a one rotor one stator type axial gap type rotating electrical machine.

(7) While, in the embodiments described above, examples were explained in which the cores 121 were made by laminating together the thin magnetic plates 121a which were made from an iron-based amorphous metallic material, the present invention should not be considered as being limited to that construction. For example, it would also be acceptable to arrange to make the cores 121 by laminating together magnetic steel sheets.

It would also be accept able to make the cores 121 from a soft magnetic material such as magnetic powder core material or the like. Even if the cores 121 are made from such a magnetic powder core material, it is still possible electrically to connect together the conductive rings 130 and the cores 121 in a reliable, simple, and easy manner by bending the bent prongs 137a of the conductive rings 130 and thereby electrically connecting them to the side surfaces of the cores 121, irrespective of the dimensional accuracy of the cores 121 in the radial direction.

(8) While, in the embodiments described above, it was arranged to press the bent prongs 137a into the side surfaces 121s of the cores 121, the present invention is not to be considered as being limited thereby. It would also be acceptable to arrange electrically to connect together the cores 121 and the bent prongs 137a by bending the bent prongs 137a, not so that they deform the cores 121, but rather so that they simply contact against the side surfaces of the cores 121.

(9) While, in the embodiments described above, examples were explained in which the projecting portions 136 and the side surfaces 121s of the cores 121 were electrically connected together, the present invention is not to be considered as being limited thereby. It will be sufficient if the conductive rings 130 are electrically connected to the projecting end portions 121e of the cores 121 in some manner.

(10) While, in the embodiments described above, examples were explained in which the cores 121 were shaped as trapezoidal prisms, the present invention is not to be considered as being limited thereby. For example, it would also be acceptable to arrange for the cores to be shaped as rectangular parallelepipeds. Moreover it would also be acceptable to arrange to make the cores 121 in a fan-shaped, by rolling up amorphous foil strips into a roll so as to form a wound iron core and by cutting the wound iron core so as to separate them in the circumferential direction.

(11) While, in the embodiments described above, examples were explained in which the conductive rings 130, 230 were provided in both axial directions of the stator 120, the present invention is not to be considered as being limited thereby. It would be sufficient to arrange to provide only one conductive ring 130, 230 in one axial direction.

(12) While, in the embodiments described above, examples were explained in which the cores 121 and the housing 180 are electrically connected together, the present invention is not to be considered as being limited thereby. It will be sufficient if at least one of the plurality of cores 121 is electrically connected to the housing 180. By doing this, it is possible to suppress the occurrence of stray current corrosion to a certain degree, as compared to a case in which none of the plurality of cores 121 are electrically connected to the housing 180.

(13) And while, in the first embodiment, an example was explained in which a pair of the groove portions 118 was provided to each of the pair of flange portions 112 of the bobbin 110 of each of the cores 121, and a conductive bar 161, 162 was housed in each of these groove portions 118, the present invention is not to be considered as being limited thereby. It would also be acceptable to arrange for the conductive bars 161, 162 to be provided to only one of the pair of flange portions 112. Moreover, it would also be possible to omit one of the pair of groove portions 118 in the flange portion 112, and only to provide one conductive bar in that one flange portion 112. Yet further, it would also be possible to provide a groove portion 118 in the bobbin 110 of at least one of the plurality of cores 121, and to house a conductive bar in that groove portion 118. By doing this, it is possible to obtain a certain beneficial shielding effect, as compared to a case in which no conductive bars are provided to the bobbin 110 of any of the plurality of cores 121.

(14) The order of the steps for manufacture, and the structures of the dies and the molds and so on, are not to be considered as being limited by the embodiments described above.

(15) While, in the third embodiment, an example was explained in which the cores 121 were held by the holding member 397 and then molded, the present invention is not to be considered as being limited by this arrangement. For example, instead of the holding member 397, it would also be possible to provide bolts that pass through the center housing 182 and the cores 121, and to hold the cores 121 with these bolts. Moreover, it would also be acceptable to arrange to hold the flange portions 112 of the bobbins 110, so as to cover the entire outer surfaces of the projecting end portions 121e of the cores 121 with the molded body 140.

(16) In the third embodiment, it would also be acceptable to arrange to omit the conductive rings 130 and/or the conductive bars 161, 162. It would be possible to provide a rotating electrical machine in which the strength with which the cores are held is increased, even if the conductive rings and/or the conductive bars are omitted.

(17) The number of the magnets 152 and the number of the cores 121 may be set as appropriate.

The present invention is not to be considered as being limited to the embodiments described above; provided that the essential characteristics of the present invention are preserved, other forms that are considered to come within the scope of the technical concept of the present invention are also included within the range of the present invention.

### REFERENCE SIGNS LIST

100: rotating electrical machine
110: bobbin
111: barrel portion
112: flange portion
115: pin
116: inner edge portion
116a: long side portion
117: outer edge portion
118: groove portion
119: takeout portion
120: stator
121: core
121a: thin magnetic plate
121c: concave portion
121e: projecting end portion
121i: inner surface
121o: outer surface
121s: side surface
121t: end surface
122: coil
130: conductive ring
131: outer circumferential portion
132: inner circumferential portion
132a: prong
133: base portion
134: slit
135: fitting hole
136: projecting portion
137: projecting prong
137a: prong to be bent
137b: support prong
138: cutaway portion
139: slit
140: molded body
150: rotor
151: casing member
151a: concave portion
152: magnet
180: housing
181: housing end member
181a: bearing support portion
182: center housing
183L: lower support projection
183U: upper support projection
186: bearing
188: rotation shaft
191: lower mold
191a: main block
191b: first circular cylindrical portion
191c: second circular cylindrical portion
193: upper mold
193a: main block
193b: first circular cylindrical portion
193c: second circular cylindrical portion
193h: injection hole
196: bending tool
200: rotating electrical machine
230: conductive member
233: base portion
300: rotating electrical machine
340: molded body
391: lower mold
391a: main block
391b: first circular cylindrical portion
391c: second circular cylindrical portion
393: upper mold
393a: main block
393b: first circular cylindrical portion
393c: second circular cylindrical portion
393h: injection hole
397: holding member
398: external circumferential portion
399: sandwiching portion
399a: opening portion
421d: die contacting region
440: molded body
441: concave portion
491: lower mold
493: upper mold
494 projecting contact portion

1. An axial gap type rotating electrical machine, comprising:
a rotor that is fixed to a rotation shaft;
a stator that is arranged to face the rotor along an axial direction of the rotation shaft;
a housing that contains the rotor and the stator; and
a resin member for holding the stator to an inner wall of the housing; wherein:
the stator comprises a plurality of cores that are arranged in a circumferential direction around the rotation shaft, an insulating bobbin that holds each of the cores, a coil that is wound upon the bobbin, and a first conductive member for shielding electrostatic coupling between the coil and the rotor;
the bobbin is formed with an opening portion for housing the core and a flange portion that surrounds the opening portion;
the flange portion is formed with a groove portion in which the first conductive member is housed;
a second conductive member that electrically connects together at least one of the plurality of cores and the housing; and
the first conductive member being sandwiched between the flange portion of the bobbin and the second conductive member.

2. (canceled)

3. The axial gap type rotating electrical machine according to claim 1, wherein:
the second conductive member contacts an end surface in the circumferential direction of at least one of the plurality of cores; and
the cores each comprise a plurality of magnetic plates that are laminated together in a radial direction of the rotation shaft.

4. The axial gap type rotating electrical machine according to claim 3, wherein:
the magnetic plates comprised in each core are made from an amorphous metallic material.

5. The axial gap type rotating electrical machine according to claim 3, wherein:
the second conductive member comprises a base portion that contacts an inner surface of the housing, and a projecting portion that projects from the base portion toward a center of the rotation shaft; and
the projecting portion contacts the end surface in the circumferential direction of the core.

6. The axial gap type rotating electrical machine according to claim 5, wherein:
a slit is provided in the projecting portion, the slit extending from an end of the projecting portion in a radially outward direction from the rotation shaft.

7. The axial gap type rotating electrical machine according to claim 3, wherein:
in the second conductive member, a circular annular base member that contacts an inner surface of the housing and a plurality of projecting portions that project from the circular annular base portion toward a center of the rotation shaft are formed integrally; and
each of the plurality of projecting portions contacts an end surface in the circumferential direction of each of the plurality of cores.
